(19) United States
(12) Patent Application Publication
(10) Pub. No.: US 2008/0195605 A1
(43) Pub. Date: Aug. 14, 2008

(54) SERVICE DIRECTORY AND MANAGEMENT SYSTEM

(75) Inventor: Lea Wolf-Soffer, San Diego, CA (US)

Correspondence Address: WILSON SONSINI GOODRICH & ROSATI, 650 PAGE MILL ROAD, PALO ALTO, CA, 94304-1050, US

(73) Assignee: ICLIQUEIN TECHNOLOGY, INC., San Diego, CA (US)

(21) Appl. No.: 12/029,391

(22) Filed: Feb. 11, 2008

Related U.S. Application Data
(60) Provisional application No. 60/889,206, filed on Feb. 9, 2007.

(51) Int. Cl. G06F 17/30

(52) U.S. Cl. 707/5; 707/3; 707/E17.014

(57) ABSTRACT

A unique process-oriented task database contains a hierarchal organization of work tasks. A service provider selects one or more tasks from the database to populate a record corresponding to the service provider; and the record is recorded in a service provider database. A consumer selects tasks from the task database to query the service provider database. The consumer then searches the service provider database with a search engine using tasks selected from the task database. The search engine returns a list of one or more service providers satisfying the search criteria, including the process-oriented task or tasks that the service provider selected from the task database.

### CROSS REFERENCE TO RELATED APPLICATIONS AND PRIORITY CLAIM

This application claims priority to United States Provisional patent application Ser. No. 60/889,206, filed Feb. 9, 2007, which is incorporated by reference herein in its entirety.

### BACKGROUND OF THE INVENTION

Consumers, whether individuals, households or businesses, often find themselves in need of services on a one-time, short term or seasonal basis. Such services are generally provided by service providers—individuals or businesses—on a contractual basis. The process of engaging such work is conceptually simple: a consumer perceives a need for a particular task to be performed, the consumer identifies and contacts a particular service provider that is able to perform the desired task, the consumer asks for, and receives, a rate quote and additional terms from the service provider, the consumer and service provider negotiate over the rate and other terms, and eventually a contract is formed when one party to the transaction makes an offer and the other party manifests an acceptance of the offer.

Although the agreement-reaching process is natural and time-honored, both consumers and service providers face obstacles in completing this process. The first obstacle faced by consumers lies in identifying a service provider who can potentially perform the task that the consumer needs to have performed. The consumer generally will not be familiar with every person in an area who possesses the skills necessary to perform the needed task. Service providers, who may be willing and available to perform the task, but who are unaware of the consumer's need, experience the parallel problem of being unable to make the initial contact with the consumer to begin the negotiation process. Thus, consumers need tools for making more focused searches for service providers and service providers need tools for directing advertisement for their services toward a more focused group of consumers—those who actually need the skill sets that they possess.

Various solutions have been developed to address this challenge to both consumers and service providers. Commercial telephone listings (yellow pages) have for years provided the first stop for consumers seeking to engage service providers on a contract basis. However, these yellow pages listings suffer a number of drawbacks. First, due to space constraints, many service providers (or advertisers) provide only the name, address and phone number of their businesses, leaving the details of their actual capabilities unknown to the consumer. This increases the cost to the consumer of contacting and engaging service providers having skill sets appropriate to the particular task that the consumer needs to have completed, as a consumer will have to call and interview a number of different service providers in order to find out whether those service providers are even able to perform the desired task. This generally causes problems for both consumers and service providers: Consumers must either limit the number of service providers they contact or spend an inordinate amount of time contacting and interviewing every listed service provider; and service providers run the risk of not being contacted at all, unless they happen to spend additional money to obtain a larger advertising space, where they can spell out their expertise in greater detail.

Part of the problem with yellow pages is the way they are organized. First, goods and services are broken into categories, which are organized alphabetically; second, service providers are organized alphabetically by name within the broad service category. Often times a service provider listed under a broad service category will be skilled in performing a particular type of task—such as installation of industrial plumbing in new builds and completely unskilled in another type of task—such as repairing residential faucets. Thus, a consumer in need of faucet repair in a residence would be required to look under “P” for plumbers, and sort through the alphabetical list of plumbers listed in the plumbers listing, including those who specialize in commercial plumbing, heavy industry plumbing, as well as the installation, maintenance and repair of plumbing. More detailed listings might be useful to the consumer; or they might not, because the particular details of the service provider's capabilities that are shared with the consumer are controlled by the service provider. A service provider may pay an additional fee to list a number of facts about the provider's business, such as phone number, address and number of years in business, which may be irrelevant to the basic questions: “What needs to be done?” and “Can the service provider do it?” Thus, even if service providers were not discouraged from sharing more about their abilities with consumers by the higher price of acquiring more advertising space in yellow pages, there is no assurance that the information provided by service providers to consumers would actually be helpful in reducing the need of consumers to directly contact numerous service providers to determine the service providers' abilities before even beginning the negotiation process. However, service providers often are pressured into acquiring larger advertising space, or paying for color advertisements, because to do otherwise would doom them to being buried in the alphabetical listings, where most consumers would fail to notice them.

As mentioned previously, this results in problems for consumers as well as service providers. Consumers may, and often do, weary of the process of identifying service providers, and simply settle on the advertiser with the first alphabetical listing or the most impressive advertisement. Consumers may thus miss out on service providers who are skilled but whose listings are buried in the alphabetical listings. Service providers also face the parallel challenges of maintaining a high enough profile for their advertisement that they attract wanted business and fielding inquiries from consumers whose needs do not line up with their abilities.

In more recent years, service providers have begun seeking better ways to advertise their services to consumers; and consumers have sought more efficient ways to obtain listings of qualified service providers. The Internet provides an attractive environment for advertising services, as Internet portals generally are not constrained so much by space limitations as hard copy yellow pages are. Unfortunately, those Internet yellow pages services that merely mimic the capabilities of paper media yellow pages still present the problem to consumers and service providers alike that the precise information that would be most relevant to the consumer—whether the advertised service provider can actually do the work that the consumer needs done—may be hidden from the consumer by the larger amount of information provided by the computer.

Consumer-driven Internet solutions, which are basically lists of contractors who have been successfully employed by various consumers, do not solve this problem—and indeed may exacerbate it. Although these services, such as Angie's List™, provide information that some consumers consider, after the fact, to have a bearing on whether they would use a particular service provider again, their content is entirely controlled by individuals, who may not include information that a consumer looking to engage a service provider for the first time would find most useful. For example, an individual looking for carpet cleaning might read that a particular flooring company responded quickly and courteously, quoted a fair price, finished promptly, cleaned up after themselves, and charged the agreed upon priced, much to the satisfaction of another consumer, only to find out, upon contacting that service provider, that the service provider is only able to install wood flooring. Thus, the consumer would have wasted not only the consumer's time—time which could have been better spent making a more relevant contact—but the service provider's time as well. While some consumers who contribute reviews to such services might very well provide such information, there is nothing purposive in the structure of such listing services to force them to do so. Even if they do provide some indication of specific tasks performed by the service provider, they may, and generally do, fail to mention other skills possessed by the service providers. Thus, because such services focus on post-contract impressions on the part of the consumer, the consumer must still, in most cases, contact the service provider directly and interview the service provider to determine if indeed the service provider has the necessary skill set to perform the desired task.

An analogous difficulty arises between individuals in social networking contexts. Social networking Internet sides provide opportunities for people who share similar interests to contact and communicate with one another. While these sites provide general categories of interests that individuals may share, these categories are broad, with hundreds or even thousands of entries appearing under those broad categories. Moreover, keyword searching on these sites can lead to hundreds of “hits”. An individual who is seeking to network with another person who shares his or her interests may need to “browse” several dozen entries in order to identify another person for networking. Moreover, given the large number of “hits” generated by these search tools, even if an individual succeeds in identifying a person with whom to communicate regarding a particular interest, there may still be a large number of entries remaining, which the individual has not had time or inclination to check. Thus there is the double disadvantage to these sites that they may require large amounts of time to search and they may also lead to individuals missing opportunities for social networking that they may have enjoyed had they had a more precise method of identifying others who share their particular interests.

### SUMMARY OF THE INVENTION

The inventor has identified a need for an improved system and method for providing information to a user of such information. The invention provides a back-end driven system and method for providing such information. The inventor has determined that, by analyzing such diverse undertakings as industry, commerce and social networking and arranging the results of such analysis in hierarchal arrangements having at least three levels of relational organization, one can provide a robust adaptable system or method for matching needs and availability of various things, such as skill sets, products, interests (e.g. hobbies), etc. Thus, in some embodiments, there is provided a computer-implemented method, or system for implementing the method, wherein the method comprises: (a) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database; (b) receiving a selection of at least one entity attribute for the first entity, wherein said at least one entity attribute is selected from the attribute database; (c) recording the at least one selected entity attribute in an attribute field in a first entity record in an entity database; (d) providing to a second entity a search engine adapted to permit the second entity to select at least one attribute for which to search from the attribute database; (e) receiving at least one search attribute selected by the second entity from the attribute database; (f) searching the contact database for an entity record containing an attribute that matches the search attribute; and (g) providing information for at least the first entity to the second entity. Some embodiments further comprise a step or apparatus for receiving registration information including identifying information and/or contact information for the first entity, and storing said registration information in a registration information field of the entity record in the entity database. In some embodiments, receiving registration information occurs after step (a) and before step (d). The system and method are adaptable and scalable to a variety of platforms, such as help wanted, situations wanted, social networking, resume listing, product offering and other computer-implemented methods and systems. Specific embodiments of such methods and systems are provided below.

Some embodiments further provide a computer system or computer-implemented method, wherein the method comprises: (a) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database; (b) receiving registration information including identifying information and contact information for a first entity, and storing said registration information in a registration information field of a record in an entity database; (c) receiving a selection of at least one attribute for the first entity, wherein said at least one attribute is selected from the attribute database; (d) recording the at least one selected attribute in an attribute field in the entity record corresponding to the first entity. In some embodiments, the system or method further comprises: (e) providing to a second entity a search engine adapted to permit the second entity to select at least one attribute from the attribute database; (f) receiving at least one search attribute selected by the second entity from the attribute database; (g) searching the entity database for an entity record containing an attribute that matches the search attribute; and (h) returning entity information for at least the first entity to the second entity. The system and method are adaptable and scalable to a variety of platforms, such as help wanted, situations wanted, social networking, resume listing, product offering and other computer-implemented methods and systems. Specific embodiments of such methods and systems are provided below.

Some embodiments provide a computer system or computer-implemented method, wherein the method comprises: (a) providing an entity database comprising a plurality of entity records, each entity record comprising at least one registration information field populated with registration information for an entity and at least one attribute field corresponding to the entity; (b) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database; (c) providing to a searcher a search engine adapted to permit the searcher to select at least one attribute for which to search from the attribute database; (d) receiving at least one search attribute selected by the searcher from the attribute database; (e) searching the entity database for an entity record containing an entity attribute that matches the search attribute; and (f) providing information for at least the first entity to the searcher. The system and method are adaptable and scalable to a variety of platforms, such as help wanted, situations wanted, social networking, resume listing, product offering and other computer-implemented methods and systems. Specific embodiments of such methods and systems are provided below.

Some embodiments provide a computer system comprising: (a) a multi-level hierarchal database comprising a multi-tier structure having at least three levels, at least one category of the first level being related to a plurality of sub-categories of a second level, and at least one sub-category of the second level being related to a plurality of attributes of a third level; (b) an entity database containing entity records containing registration information fields and attribute fields for a plurality of entities, wherein the attribute fields contain entity attributes selected from the attribute database of (a); (c) a means for receiving registration information and attributes corresponding to a plurality of entities, wherein the attributes must be selected from the multi-level hierarchal database of (a); (d) a means for receiving search information, wherein the search information includes at least one search attribute, and at least one search attribute must be selected from the multi-level hierarchal database of (a); (e) a means for comparing the search information from (d) with the entity attributes corresponding to each of the plurality of entities recorded in the entity database; and (f) a means for displaying the results of the search from (e). The system and method are adaptable and scalable to a variety of platforms, such as help wanted, situations wanted, social networking, resume listing, product offering and other computer-implemented methods and systems. Specific embodiments of such methods and systems are provided below.

The inventor has further identified a need for a service directory system, and service management system that would permit a consumer to circumvent the time-consuming process of interviewing a number of service providers to determine if they possess the particular skills necessary to carry out the tasks that the consumer needs to have completed. There is furthermore a need for such a service directory and service management system, which would facilitate the initial communication between the consumer and the service provider who has the ability to perform the desired task. There is also a need for such a service directory and service management system, which would further provide a means for establishing an agreement between the consumer and the service provider. There is additionally a need for such a service directory and service management system, which would provide a means for tracking the progress of work after an agreement has been made, invoicing after work has been completed and providing feedback, including community-available feedback—after the work has been completed. The invention described herein satisfies these needs and provides related advantages as well.

The foregoing and related needs are met by embodiments described herein. In some embodiments, the invention provides a method of facilitating contact between at least one consumer and at least one service provider, comprising: providing a process-oriented task database wherein the tasks are arranged in a multi-level hierarchal arrangement such that a first level is the industry level, an intermediate level is the industry sector, and a final level is the task; receiving service provider registration information including contact information from at least one service provider and recording the at least one service provider's registration information in a service provider database; providing to the at least one service provider a search engine adapted to permit selection of at least one task from the process-oriented task database; receiving from the service provider at least one selection of a task from the process-oriented task database; recording the selected task in the service provider database; providing to the at least one consumer a search engine adapted to permit selection of at least one task from the process-oriented task database; receiving from the at least one consumer a selection of at least one task; comparing the at least one consumer's at least one selected task with the provider's at least one selected task; and, if the consumer's at least one selected task matches at least one provider's at least one selected skill: providing to the at least one consumer contact information for at least one service provider whose at least one selected task matches the consumer's at least one selected task, mediating contact between at least one the at least one consumer and the at least one service provider, or both, wherein the search engines provided to both the service provider and the consumer are hierarchal click-through search engines such that a first level is the industry level, an intermediate level is the industry sector, and a final level is the task. In some embodiments, the search engine adapted to permit selection of at least one task from the process-oriented task database is a hierarchal click-through search engine. In some embodiments, the method further comprises providing to the at least one consumer, the at least one service provider, or both, a work management platform. In some embodiments, the work management platform comprises one or more members of the group consisting of: a contacts list, a references list, a service directory, and a service contracts management system and community information. In some embodiments, the work management platform comprises community information including one or more members of the group consisting of a bulletin board, a community events calendar, a discussion forum, a lost and found and a service rating forum. In some embodiments, the method further comprises providing to at least one consumer, at least one service provider, or both, a community environment comprising a discussion forum. In some embodiments, the discussion forum is arranged by forum topics, a rating forum or both. In some embodiments, the work management platform comprises a contracting environment adapted to facilitate at least one consumer in making at least one work agreement with at least one service provider. In some embodiments, the contracting environment is adapted to permit at least one consumer, at least one service provider, or both, to perform one or more of the following functions: schedule work appointments, provide reminders of work appointments, enter into work contracts, track work progress, deliver one or more invoices, conduct marketing, submit proposals in a click-through environment or track one or more projects in a click-through environment. In some embodiments, the method further comprises charging a fee to at least one service provider. In some embodiments, the method further comprises charging a registration fee to at least one service provider. The In some embodiments, the method further comprises charging at least one service provider a fee that is based on the number of consumers to whom the service provider's identifying information, contact information, or both, has been provided. In some embodiments, the method further comprises receiving from at least one service provider pricing information for performing at least one task in accordance with the provider's at least one selected task. In some embodiments, the method further comprises recording the pricing information in a database. In some embodiments, the method further comprises providing the pricing information to at least one consumer. In some embodiments, the method further comprises mediating contact between at least one consumer and at least one service provider. In some embodiments, contact is mediated at least in part by providing contact information for at least one consumer to at least one service provider. In some embodiments, the contact information for at least one consumer is transmitted to at least one service provider by one or more of: email, telephone, voice over Internet protocol messaging (VOIP), Internet instant messaging (IM) or wireless text messaging. In some embodiments, the method further comprises charging a fee to at least one consumer. In some embodiments, the method further comprises charging a registration fee to at least one consumer. In some embodiments, the method further comprises charging at least one consumer a basic registration fee or a premium registration fee. In some embodiments, the method further comprises determining whether at least one consumer has been charged a basic registration fee or a premium registration fee; and providing to the at least one consumer identifying information for a first pre-determined maximum number of service providers according to a first pre-determined unit of time if the consumer has been charged the basic registration fee, or providing to the at least one consumer identifying information for a second pre-determined maximum number of service providers according to a second pre-determined unit of time if the consumer has been charged the premium registration fee. In some embodiments, the hierarchal arrangement of tasks comprises at least two levels of organization, including a level corresponding to the industry and a level corresponding to the task. In some embodiments, the hierarchal arrangement of tasks further comprises at least one additional level of organization. In some embodiments, the at least one additional level of organization is selected from an industry sector and a general task category. In some embodiments, the highest (most general) level of organization of the hierarchal arrangement of tasks is the level corresponding to the industry, the intermediate level is the level corresponding to the industry sector level, and the lowest (most specific) level of organization is the level corresponding to task level. In some embodiments, the method further comprises receiving profile data from at least one consumer, at least one service provider, or both. In some embodiments, the method further comprises recording the profile data in a database. In some embodiments, the profile data are received from at least one consumer. In some embodiments, the profile data are received from at least one service provider. In some embodiments, profile data comprise at least one of: a skill set, an experience profile, hobbies, language abilities, and highest level of education attained. In some embodiments, the method further comprises receiving a review of at least one service provider from at least one consumer. In some embodiments, the method further comprises storing the review in a database. In some embodiments, the method further comprises receiving a help request from at least one consumer and providing the help request in a listing viewable by at least one other consumer, at least one service provider or both. In some embodiments, the method further comprises providing to at least one consumer, at least one service provider, or both, at least one of: a service offerings listing and a frequently asked question (FAQ) listing. In some embodiments, the method further comprises: receiving a request for a background check from at least one requestor selected from consumers and service providers; and providing a background check report to the at least one requestor. In some embodiments, at least one requestor is a consumer and the background check relates to a service provider. In some embodiments, at least one requestor is a service provider and the background check relates to a consumer. In some embodiments, the method further comprises: receiving rating information relating to at least one service provider recording the rating information in a record; receiving from the at least one consumer a list of one or more authorized individuals who may view the rating information; and providing access whereby one or more authorized individuals may view the rating information.

In some embodiments, the invention provides a method of advertising a service, comprising: providing to at least one service provider a search engine adapted to permit selection of at least one task from a process-oriented task database wherein the tasks are arranged in a multi-level hierarchal arrangement such that a first level is the industry level, an intermediate level is the industry sector, and a final level is the task; receiving from at least one service provider a selection of at least one task; receiving from the at least one service provider a request to advertise the at least one service provider's selected task; providing to the at least one consumer a search engine adapted to permit selection of at least one task from the process-oriented task database; receiving from the at least one consumer a selection of at least one task; comparing the at least one consumer's at least one selected task with the provider's at least one selected task; and, if the consumer's at least one selected task matches at least one provider's at least one selected skill: transmitting an advertisement on behalf of the service provider to at least one consumer, wherein the search engines provided to both the service provider and the consumer are hierarchal click-through search engines such that a first level is the industry level, an intermediate level is the industry sector, and a final level is the task. In some embodiments, the method further comprises: receiving identifying information and contact information from one or more consumers; and selecting from the consumers a group of consumers to whom the advertising is to be sent In some embodiments, the method further comprises: providing to at least one consumer a search engine adapted to permit selection of at least one task from a process-oriented task database; receiving from the at least one consumer at least one selection of at least one task from the process-oriented task database; recording the at least one selection of at least one desired skill in the process-oriented task database; comparing the service provider's selected task with the consumer's selected task; and when there is a match between the service provider's selected task and the consumer's selected task: assigning the consumer to the group of consumers. In some embodiments, the search engine is adapted to permit selection of at least one task from the process-oriented task database is a hierarchal click-through search engine In some embodiments, the process-oriented task database comprises at least two levels of organization, including a level corresponding to the industry and a level corresponding to the task. In some embodiments, the click-through search engine comprises at least one additional level of organization. In some embodiments, at least one additional level of organization is selected from an industry sector and a general task category. In some embodiments, the highest (most general) level of organization of the hierarchal click-through search engine is the level corresponding to the industry, the intermediate level is the level corresponding to the industry sector, and the lowest (most specific) level of organization is the level corresponding to task. In some embodiments, the search engine is adapted to narrow results by location. In some embodiments, the method further comprises: charging at least one service provider a fee. In some embodiments, the fee is charged on a per-request basis, on a per-unit time basis or on a per-consumer basis.

In some embodiments, the invention comprises a method of help-wanted advertising, comprising: providing to at least one consumer a search engine adapted to permit selection of at least one task from a process-oriented task database wherein the tasks are arranged in a multi-level hierarchal arrangement such that a first level is the industry level, an intermediate level is the industry sector, and a final level is the task; receiving from the at least one consumer at least one selected task; receiving from the at least one consumer a request to advertise the consumer's at least one selected task; and providing to the at least one consumer a search engine adapted to permit selection of at least one task from the process-oriented task database; receiving from the at least one consumer a selection of at least one task; comparing the at least one consumer's at least one selected task with the provider's at least one selected task; and, if the consumer's at least one selected task matches at least one provider's at least one selected skill: transmitting an advertisement on behalf of the service provider to at least one consumer, wherein the search engines provided to both the service provider and the consumer are hierarchal click-through search engines such that a first level is the industry level, an intermediate level is the industry sector, and a final level is the task. In some embodiments, the search engine adapted to permit selection of at least one task from the process-oriented task database is a hierarchal click-through search engine. In some embodiments, the process-oriented task database comprises at least two levels of organization, including a level corresponding to the industry and a level corresponding to the task. In some embodiments, the click-through search engine comprises at least one additional level of organization. In some embodiments, at least one additional level of organization is selected from an industry sector and a general task category. In some embodiments, the highest (most general) level of organization of the hierarchal click-through search engine is the level corresponding to the industry, the intermediate level is the level corresponding to the industry sector, and the lowest (most specific) level of organization is the level corresponding to task. In some embodiments, the search engine is adapted to narrow results by location. In some embodiments, the search engine is adapted to narrow results by amount of time the job has been advertised. In some embodiments, the method further comprises: providing to at least one service provider a search engine adapted to permit selection of at least one task from the process-oriented task database; receiving from at least one service provider at least one selected task; and comparing the at least one consumer's selected task with the at least one service provider's selected task. In some embodiments, the search engine adapted to permit selection of at least one task from the process-oriented task database is a hierarchal click-through search engine. In some embodiments, the search engine comprises at least two levels of organization, including a level corresponding to the industry and a level corresponding to the task. In some embodiments, the click-through search engine comprises at least one additional level of organization. In some embodiments, at least one additional level of organization is selected from an industry sector and a general task category. In some embodiments, the highest (most general) level of organization of the hierarchal click-through search engine is the level corresponding to the industry, the intermediate level is the level corresponding to the industry sector, and the lowest (most specific) level of organization is the level corresponding to task. In some embodiments, the method further comprises charging at least one consumer a fee. In some embodiments, the fee is charged on a per-request basis, on a per-unit time basis or on a per-service provider basis.

In some embodiments, the invention comprises a method of facilitating skill set matching in an automated computer environment, comprising: recording a plurality of industry categories; for each industry category, recording a plurality of industry sectors; for each industry sector, recording a plurality of tasks; arranging the plurality of tasks in a process-oriented task database according to industry, industry sector, and optionally one or more additional categories; providing to a service provider a search engine adapted to permit selection of one or more tasks from the process-oriented task database; receiving from the service provider identifying information and at least one selected task; recording the service provider's selected task and the identifying information in a service provider database; providing to at least one consumer a search engine adapted to permit selection of at least one task from the process-oriented task hierarchal task database; comparing the at least one consumer's selected task the at least one service provider's selected task; and, if the at least one consumer's selected task matches the at least one service provider's selected task: providing to the consumer contact information for at least one service provider whose provider skill matches the desired task, mediating contact between at least one the at least one consumer and at least one service provider, or both, wherein the search engines provided to both the service provider and the consumer are hierarchal click-through search engines such that a first level is the industry level, an intermediate level is the industry sector, and a final level is the task. In some embodiments, the search engine adapted to permit selection of at least one task from the process-oriented task database is a hierarchal click-through search engine. In some embodiments, the computer environment is an integrated dispersed network environment. In some embodiments, the integrated dispersed network environment is an intranet, an extranet or a combination thereof. In some embodiments, the extranet is the Internet. In some embodiments, the method further comprises providing to the at least one consumer, the at least one service provider, or both, a work management platform. In some embodiments, the work management platform comprises one or more members of the group consisting of: a contacts list, a references list a service directory, a service contracts management system, and community information. In some embodiments, the work management platform comprises community information including one or more members of the group consisting of a bulletin board, a community events calendar, a discussion forum, a lost and found and a service rating forum. In some embodiments, the method further comprises providing to at least one consumer, at least one service provider, or both, a community environment comprising a discussion forum. In some embodiments the discussion forum is arranged by forum topics, a rating forum, or both. In some embodiments the work management platform comprises a contracting environment adapted to facilitate at least one consumer in making at least one work agreement with at least one service provider. In some embodiments, the contracting environment is adapted to permit at least one consumer, at least one service provider, or both, to perform one or more of the following functions: schedule work appointments, provide reminders of work appointments, enter into work contracts, track work progress, deliver one or more invoices, conduct marketing, submit proposals in a click-through environment or track one or more projects in a click-through environment. In some embodiments, the method further comprises charging a fee to at least one service provider. In some embodiments, the method further comprises charging a registration fee to at least one service provider. In some embodiments, the method further comprises charging at least one service provider a fee that is based on the number of consumers to whom the service provider's identifying information, contact information, or both, has been provided. In some embodiments, the method further comprises receiving from at least one service provider pricing information for performing at least one task in accordance with the provider's at least one selected task. In some embodiments, the method further comprises recording the pricing information in a database. In some embodiments, the method further comprises providing the pricing information to at least one consumer. In some embodiments, the method further comprises mediating contact between at least one consumer and at least one service provider. In some embodiments, contact is mediated at least in part by providing contact information for at least one consumer to at least one service provider. In some embodiments, the contact information for at least one consumer is transmitted to at least one service provider by one or more of: email, telephone, voice over Internet protocol messaging (VOIP), Internet instant messaging (IM) or wireless text messaging. In some embodiments, the method further comprises charging a fee to at least one consumer. In some embodiments, the method further comprises charging a registration fee to at least one consumer. In some embodiments, the method further comprises charging at least one consumer a basic registration fee or a premium registration fee. In some embodiments, the method further comprises determining whether at least one consumer has been charged a basic registration fee or a premium registration fee; and providing to the at least one consumer identifying information for a first pre-determined maximum number of service providers according to a first pre-determined unit of time if the consumer has been charged the basic registration fee, or providing to the at least one consumer identifying information for a second pre-determined maximum number of service providers according to a second pre-determined unit of time if the consumer has been charged the premium registration fee In some embodiments the process-oriented task database comprises at least two levels of organization, including a level corresponding to the industry and a level corresponding to the task. In some embodiments, the task database further comprises at least one additional level of organization. In some embodiments, at least one additional level of organization is selected from an industry sector and a general task category. In some embodiments the highest (most general) level of organization of the hierarchal click-through search engine is the level corresponding to the industry, the intermediate level is the level corresponding to the industry sector, and the lowest (most specific) level of organization is the level corresponding to task. In some embodiments, the search engine is adapted to narrow results by location. In some embodiments, the method further comprises receiving profile data from at least one consumer, at least one service provider, or both. In some embodiments, the method further comprises recording the profile data in a database. In some embodiments, the profile data are received from at least one consumer. In some embodiments, the profile data are received from at least one service provider. In some embodiments, the profile data comprise at least one of: a skill set, an experience profile, hobbies, language abilities, and highest education attained. In some embodiments, the method further comprises: receiving a review of at least one service provider from at least one consumer. In some embodiments, the method further comprises storing the review in a database. In some embodiments, the method further comprises receiving a help request from at least one consumer and providing the help request in a listing viewable by at least one other consumer, at least one service provider or both. In some embodiments, the method further comprises providing to at least one consumer, at least one service provider, or both, at least one of: a service offerings listing and a frequently asked question (FAQ) listing. In some embodiments, the method further comprises: receiving a request for a background check from at least one requestor selected from consumers and service providers; and providing a background check report to the at least one requestor. In some embodiments, at least one requester is a consumer and the background check relates to a service provider. In some embodiments at least one requester is a service provider and the background check relates to a consumer. In some embodiments, the method further comprises: receiving rating information relating to at least one service provider; recording the rating information in a record; receiving from the at least one consumer a list of one or more authorized individuals who may view the rating information; and providing access whereby one or more authorized individuals may view the rating information.

In some embodiments, the invention further comprises a method of facilitating service management, comprising: providing a process-oriented task database, wherein the tasks are arranged in a multi-level hierarchal arrangement such that a first level is the industry level, an intermediate level is the industry sector, and a final level is the task; providing to at least one service provider a search engine adapted to permit selection of one or more skills from the process-oriented task database; receiving from the service provider contact information; receiving from the service provider at least one selected task; receiving from the service provider a rate for each of the at least one selected task; providing to at least one consumer a search engine adapted to permit selection of one or more tasks from the process-oriented task database; receiving from the at least one customer at least one selected task; comparing the at least one customer's at least one selected task with the at least one service provider's at least one selected task; if the at least one customer's at least one selected task matches the at least one service provider's at least one selected task, optionally: providing to the at least one consumer the at least one service provider's contact information; providing the at least one consumer the option to send an offer for engagement to perform the consumer's selected task to the at least one service provider; receiving from the at least one consumer a request to present an offer for engagement to the at least one service provider; and providing the offer for engagement to the service provider; and wherein the search engines provided to both the service provider and the consumer are hierarchal click-through search engines such that a first level is the industry level, an intermediate level is the industry sector, and a final level is the task. In some embodiments, the search engine adapted to permit selection of a task from the hierarchal task database is a click-through search engine. In some embodiments, the method further comprises: providing the at least one service provider with the option to accept the offer of engagement, to propose a counter-offer to the consumer or to reject the offer of engagement; receiving from the at least one service provider an election of the option to accept the offer of engagement, to propose a counter-offer to the consumer or to reject the offer of engagement; and if the at least one service provider elects to accept the offer, transmitting the acceptance to the consumer, thereby forming an agreement for the service provider to perform a service for the consumer; or if the at least one service provider elects to propose a counter offer, receiving terms for a counter offer from the service provider and transmitting the terms of the counter offer to the consumer; or if the provider elects to reject the offer, transmitting a notice of rejection to the consumer. In some embodiments, the method further comprises: receiving from the at least one consumer, the at least one service provider, or both, an indication that the agreed upon service has been completed by the service provider; and generating an invoice from the service provider to the consumer. In some embodiments, the method further comprises: receiving from the consumer, the service provider, or both, an indication that the agreed upon service has been completed by the service provider; providing to the consumer a service provider rating form; and receiving a completed service provider rating from the consumer. In some embodiments, the method further comprises providing the completed service provider rating to the service provider, a third party or both. In some embodiments, the method further comprises providing scheduling assistance to the consumer, the service provider or both.

In some embodiments, the invention provides a method of facilitating contact between a first person and a second person, comprising: providing an activity-oriented hobby database comprising a multi-level hierarchal arrangement of activities wherein the activities are arranged in a multi-level hierarchal arrangement such that a first level is the category, an intermediate level is the sub-category, and a final level is the activity; receiving registration information from the first person and the second person and recording the registration information in a contact database wherein the registration information includes contact information, gender, age; and location; providing to the first person a search engine adapted to permit selection of at least one activity from the activity-oriented hobby database; receiving from the first person at least one selection of an activity from the activity-oriented hobby database; recording the selected activity in the contact database; providing to the second person a search engine adapted to permit selection of at least one activity from the activity-oriented hobby database; receiving from the second person a selection of an activity; comparing the second person's selected activity to the first person's selected activity; and, if the first person's selected activity matches the second person's selected activity and optional preferences: providing to the second person contact information for the first person, mediating contact between the first person and the second person, or both; and wherein the search engines provided to both the first person and the second person are hierarchal click-through search engines such that a first level is a category level, an intermediate level is a sub-category level, and a final level is the activity level. In some embodiments, the search engine further comprises the ability to narrow the search by at least one of: age, location, and gender. In some embodiments, the method further comprises providing to the first person, the second person, or both, a contact management platform. In some embodiments, the contact management platform comprises a web log (blog), an electronic mail (email) interface, an instant messaging (IM) interface, a text messaging interface, a voice over internet protocol (VOIP) interface, web-based video interface or other electronic medium interface. In some embodiments, the contact management platform comprises community information including one or more members of the group consisting of a bulletin board, a community events calendar, a discussion forum, a lost and found and a comments forum. In some embodiments, the method further comprises providing to the first person, the second person or both a community environment comprising a discussion forum. In some embodiments, the discussion forum is arranged by forum topics, a rating forum, or both. In some embodiments, the method further comprises charging a fee to the first person, the second person or both. In some embodiments, the method further comprises charging a registration fee to the first person, the second person or both. In some embodiments, the method further comprises charging the first person, the second person or both a periodic fee. In some embodiments, the method further comprises providing advertising to the first person, the second person or both. In some embodiments, the method further comprises collecting an advertising fee from an advertiser. In some embodiments, the fee is charged on a per-display basis, on a per-click basis or both. In some embodiments, the method further comprises mediating contact between the first person and the second person. In some embodiments, contact is mediated at least in part by providing contact information for second person to the first person or for the first person to the second person. In some embodiments, the contact information for the second person is transmitted to the second person by one or more of: email, telephone, voice over Internet protocol messaging (VOIP), Internet instant messaging (IM) or wireless text messaging. In some embodiments, the hierarchal arrangement of activities comprises at least two levels of organization, including a level corresponding to a main category and a level corresponding to the a specific activity. In some embodiments, the hierarchal arrangement of activities further comprises at least one additional level of organization. In some embodiments, at least one additional level of organization is a sub-category. In some embodiments, the highest (most general) level of organization of the hierarchal arrangement of activities is a level corresponding to a main category, the intermediate level is a sub-category, and the lowest (most specific) level of organization is the level corresponding to task level. In some embodiments, the method further comprises receiving profile data from at least person. In some embodiments, the method further comprises recording the profile data in a database. In some embodiments, the profile data comprise at least one of: age, location, gender, a skill set, an experience profile, hobbies, language abilities, and highest level of education attained.

In some embodiments, the invention comprises a method of advertising a product, comprising: providing to at least one service provider a search engine adapted to permit selection of at least one product from a process-oriented product database wherein the products are arranged in a multi-level hierarchal arrangement such that a first level is the industry level, an intermediate level is the industry sector, and a final level is the product; receiving from the at least one service provider at least one selected product; receiving from the at least one service provider a request to advertise the service provider's at least one selected product; and providing to at least one consumer a search engine adapted to permit selection of at least one product from the process-oriented product database; receiving from the at least one consumer a selection of at least one product; comparing the at least one consumer's at least one selected product with the service provider's at least one selected product; and, if the consumer's at least one selected product matches at least one service provider's at least one selected product: transmitting an advertisement on behalf of the service provider to at least one consumer, wherein the search engines provided to both the service provider and the consumer are hierarchal click-through search engines such that a first level is the industry level, an intermediate level is the industry sector, and a final level is the product. In some embodiments, the method further comprises: receiving identifying information and contact information from one or more consumers; and selecting from the consumers a group of consumers to whom the advertising is to be sent. In some embodiments, the method further comprises: providing to at least one consumer a search engine adapted to permit selection of at least one product from a process-oriented product database; receiving from the at least one consumer at least one selection of at least one product from the process-oriented product database; recording the at least one selection of at least one desired product in the process-oriented task database; comparing the service provider's selected product with the consumer's selected product; and when there is a match between the service provider's selected product and the consumer's selected product: assigning the consumer to the group of consumers. In some embodiments, the method further comprises an additional level of organization In some embodiments the highest (most general) level of organization of the hierarchal click-through search engine is the level corresponding to the industry, a first intermediate level is the level corresponding to the industry sector, a second intermediate level is the level corresponding to the activity, and the lowest (most specific) level of organization is the level corresponding to the product. In some embodiments, the activity level comprises the choices: buy, sell, lease, and rent. In some embodiments, the search engine is adapted to narrow results by location. In some embodiments, the method further comprises: charging at least one service provider a fee. In some embodiments, the fee is charged on a per-request basis, on a per-unit time basis or on a per-consumer basis.

In some embodiments, the invention comprises a method of storing and presenting human capital information, comprising: (a) providing a human resource attributes database wherein the database is arranged as a multi-level hierarchy, wherein the hierarchy is divided into at least three levels, and wherein the first level is attribute type, an intermediate level is a sub-category of the attribute type, and a final level is the specific human resource attribute; (b) receiving biographical information from at least one human resource and recording the biographical information the database to create a human resource record; (c) providing a database population application adapted to permit hierarchal selection of at least one attribute type, at least one sub-category of the attribute type, and at least one specific human resource attribute; (d) receiving from a human resource one or more human resource attributes; (e) recording the human resource attributes in one or more human resource attribute fields of the record, wherein each human resource attribute field corresponds to an attribute type; (f) providing a search engine adapted to permit selection from the database of at least one attribute type, at least one sub-category of the attribute type, and at least one specific human resource attribute; (g) comparing the selected human resource attributes to the human resource attributes stored in the records in the database; and if there is a match: (h) providing biographical information for the human resource possessing the desired human resource attribute. In some embodiments, the human resource is an individual. In some embodiments, the human resource is a group. In some embodiments, one or more human resource attributes are arranged in a multi-level hierarchal structure having 2, 3, 4, 5 or more levels, with attribute type representing the highest level of organization. In some embodiments, the search engine is a hierarchal click-through search engine. In some embodiments, the method further comprises providing to the searcher a means for contacting the human resource. In some embodiments, the means for contacting the human resource is: email, telephone, voice over Internet protocol messaging (VOIP), Internet instant messaging (IM) or wireless text messaging.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of certain embodiments of the present invention will be obtained by reference to the following detailed description that sets forth illustrative embodiments, in which the principles of the invention are utilized, and the accompanying drawings of which:

FIGS. 1A-1C depict the logical hierarchal structure of a generic category (industry) “Software.” FIG. 1C depicts the hierarchal structure of the database under the “Software Management” sub-category of the “Software” category. The sub-category “Software Management” can be divided into several tasks (skills), which describe functions performed by individuals within the software development sector.

FIGS. 1A-1C depict the logical hierarchal structure of a generic category (industry) “Flooring.” FIG. 1C depicts the hierarchal structure of the database under the “Carpet” sub-category of the “Flooring” category (industry.) The carpet sub-category is divided into several categories, such as: Supervise Design, Install, Repair, Cleaning-Maintenance and Removal.

FIG. 3 depicts an example screen for selecting tasks (skills) from the task database.

FIG. 4 is a flow chart for a registration method for a user—individual or business—of a system according to the present invention.

FIG. 5 is a high level flow chart for a system according to the present invention.

FIG. 6 is a screen capture of the iChamba homepage.

FIG. 7 is a screen capture of the member login page.

FIG. 8 is a screen capture of the registration page.

FIG. 9 is a screen capture of the People Directory page.

FIG. 10 is a screen capture of the People Directory page showing the Location Search options expanded.

FIG. 11 is a screen capture of the People Directory page showing the Member Selection options expanded.

FIG. 12 is a screen capture of the People Directory page with Business Provider selected from the Member Selections options.

FIG. 13 is a screen capture of the Service Directory page.

FIG. 14 is a screen capture of the Service Directory page showing the Location options expanded.

FIG. 15 is a screen capture of the Service Directory page with the State & City option selected from the Locations options, and with the State options expanded.

FIG. 16 is a screen capture of the Service Directory page showing the Industry options expanded.

FIG. 17 is a screen capture of the Service Directory page showing the expansion of the Specialty options for the selected Industry: Landscape, Garden.

FIG. 18 is a screen capture of the Posted Ads page.

FIG. 19 is a screen capture of the Posted Ads page showing the expansion of the Locations options.

FIG. 20 is a screen capture of the Posted Ads page showing the expansion of the Industry options.

FIG. 21 is a screen capture of the Posted Ads page showing the expansion of the Specialty options for the selected Industry: Professional Service.

FIG. 22 is a screen capture of the Posted Ads page showing the expansion of the Job Opening Since

FIG. 23 is a screen capture of the Social Networking page.

FIG. 24 is a screen capture of the Social Networking page showing the expansion of the Locations options.

FIG. 25 is a screen capture of the Social Networking page showing the expansion of the Member Selection options.

FIG. 26 is a screen capture of the Social Networking page showing the Social Networking page after selecting Business-No Service from the Member Selection menu.

FIG. 27 is a screen capture of the Membership Products and Services page.

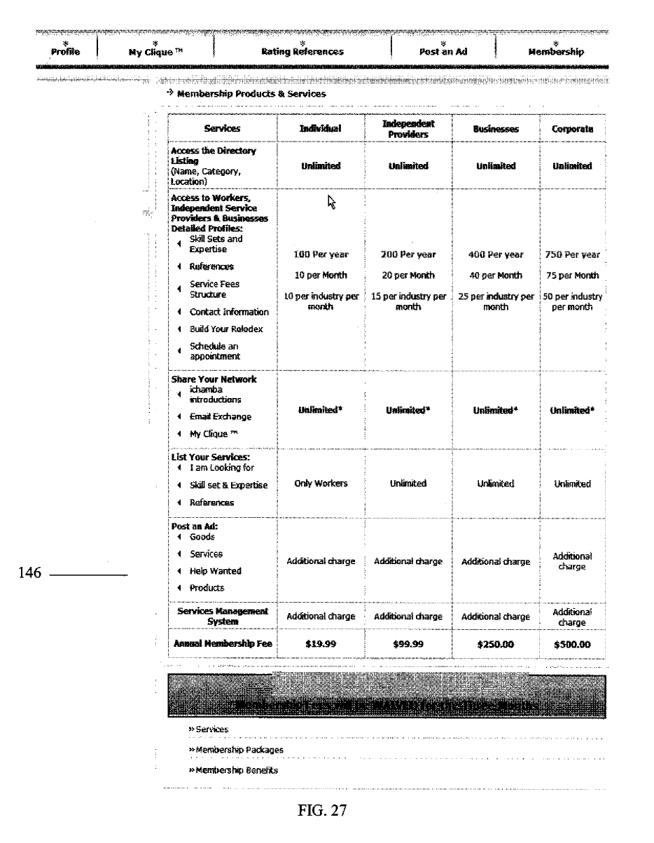

FIG. 28 is a screen capture of the Membership Packages page.

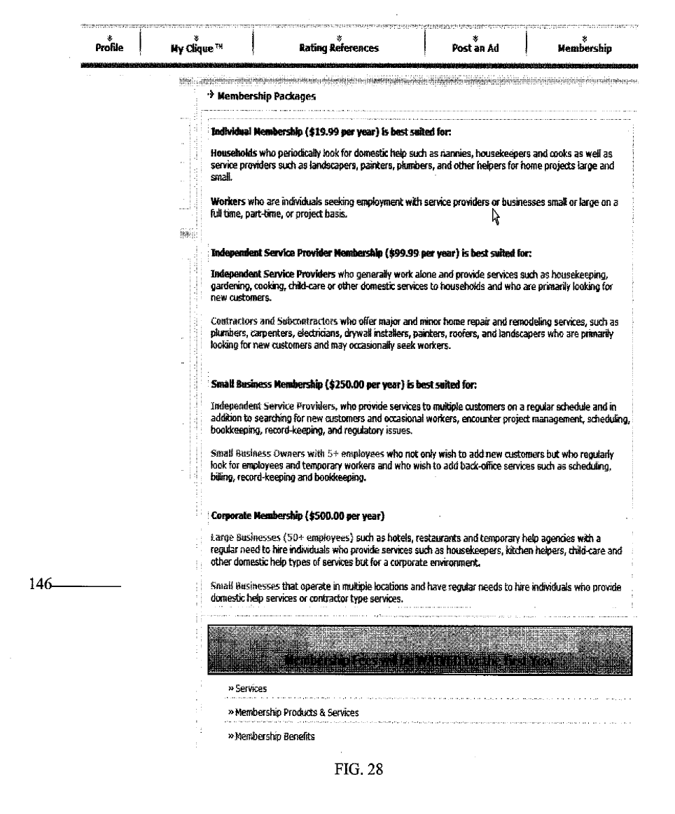

FIG. 29 is a screen capture of the Membership Benefits page.

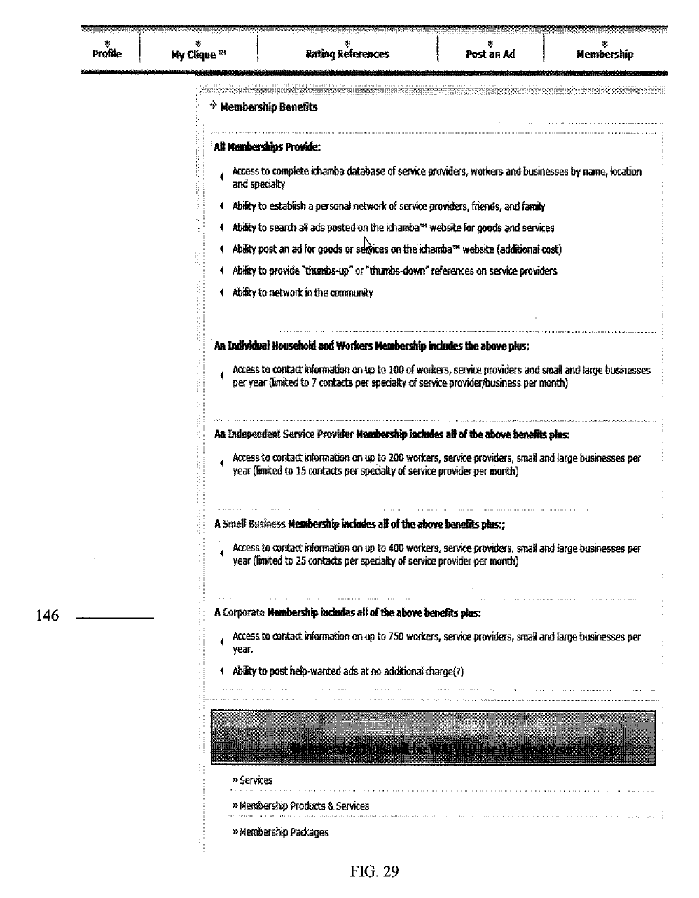

FIG. 30 is a screen capture of the Contact page.

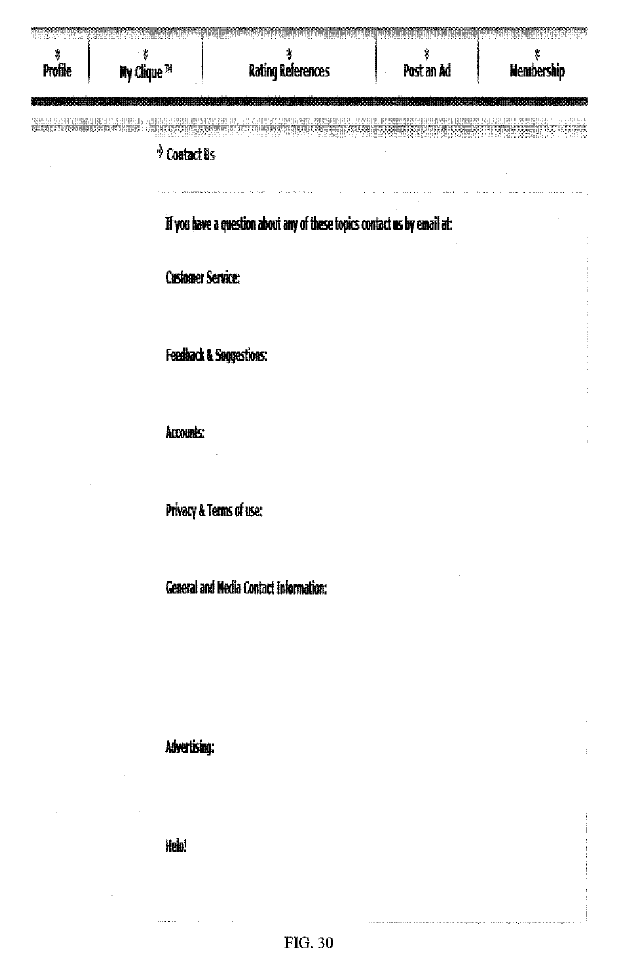

FIG. 31 is a screen capture of the Post an Ad page.

FIG. 32 is a screen capture of the Post an Ad page wherein the category selected is Help Wanted, the Industry is Professional Services, the Specialty is Attorney with 5-7 years of experience, the Education Requirements is Masters Degree or Higher, and the Language Requirements are Speaking, Reading, and Writing in Chinese.

### DETAILED DESCRIPTION OF THE INVENTION

Thus, in some embodiments, there is provided a computer-implemented method, or system for implementing the method, wherein the method comprises: (a) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database; (b) receiving a selection of at least one entity attribute for the first entity, wherein said at least one entity attribute is selected from the attribute database; (c) recording the at least one selected entity attribute in an attribute field in a first entity record in an entity database; (d) providing to a second entity a search engine adapted to permit the second entity to select at least one attribute for which to search from the attribute database; (e) receiving at least one search attribute selected by the second entity from the attribute database; (f) searching the contact database for an entity record containing an attribute that matches the search attribute; and (g) providing information for at least the first entity to the second entity. Some embodiments further comprise a step or apparatus for receiving registration information including identifying information and/or contact information for the first entity, and storing said registration information in a registration information field of the entity record in the entity database. In some embodiments, receiving registration information occurs after step (a) and before step (d). The system and method are adaptable and scalable to a variety of platforms, such as help wanted, situations wanted, social networking, resume listing, product offering and other computer-implemented methods and systems. Specific embodiments of such methods and systems are provided below.

An entity can be a person, a product, a service or other type of thing (real or abstract) for which one may search. Where reference is made to an entity herein, it is to be understood that an entity can be represented by a proxy for the entity: e.g. a business entity can be represented by an employee or contracted agent. At least one entity is generally a person, whereas the second entity may be a person, product, service or other thing.

A person can be an individual or a group. An individual can be any individual, such as a job seeker, a person seeking full-time or part-time employment, an prospective employer, a contractor, a subcontractor, an occasional worker, a person seeking a social networking opportunity, a person seeking to advertise for a social networking opportunity, etc. A group can be any group, including a household or a business concern. A business concern can be any business concern, including a sole proprietorship, a partnership, a company, a corporation, a joint venture or other business concern. Where reference is made to a person herein, whether an individual or a group, it is to be understood that a proxy for the person may stand in the shoes of the person, carrying out one or more functions of the method on behalf of the person.

An attribute database is a hierarchal database having at least three levels (and in some cases more than three levels), which are related to one another. A first level of organization may be conceptualized as a category level. At least one category at the first level is related to a plurality of sub-categories at the second level; and at least one sub-category at the second level is related to a plurality of attributes at the third level. Although three levels are presented herein, additional levels may be present in the attribute database. These levels may be thought of as being relationally interposed, where they exist, between the sub-category and the attribute levels of organization. The system and method of the invention is back-end driven, meaning that an operator of the method first analyzes an industry or other human endeavor (such as product sales or social networking) to devise at least a three-level hierarchal arrangement of attributes. This hierarchal database is used to construct an entity database, which contains contact information, identifying information and at least one attribute corresponding to the entity. This entity database is searchable. In preferred embodiments, a search engine for searching the entity database draws at least some of its search terms from the same attribute database as was used to construct the entity database. In this way, both the one providing the information and the searcher are forced to use the same language to describe the product, service or other thing (whether real or abstract). Thus, there is provided a back-end driven database and search engine, which is adaptable and scalable to a variety of environments. By providing a common language for storing and searching functions, the method or system provides efficiency in searching, e.g. by reducing the number of false hits, increasing the number of true hits and reducing the amount of time spent searching. In some embodiments, the amount of time spent searching is reduced by permitting (or forcing) population of the entity database using a hierarchal click-through application, using one or more hyperlinks, drop-down menus, radio buttons, check-boxes, etc. For example, in some cases, a category may be selected from a first level by a drop-down menu, which cases a second level to be populated with a list of sub-categories, which are displayed as a plurality of check boxes; and checking one or more check boxes from the sub-categories in the second level results in presentation of a list of attributes corresponding to each sub-category, from which list one or more attributes may be selected, e.g. by checking a check box for each attribute.

An entity record according to the invention includes identifying information in one or more identifying information fields, contact information in one or more contact information fields, and at least one attribute field. Identifying information fields can include name, first name, last name, middle name (or initial), a serial number or other identifier. In embodiments where the entity is a good or service, the identifying information can include a noun name and a unique product identifier. In embodiments where the entity is a person, the identifying information can include a unique identifier, such as a customer number, a vendor number or other identifier.

Contact information can include any information necessary for contacting an individual or group associated with the entity. Where the entity is an individual, contact information can include the individual's post office address, the individual's street address, the individual's phone number, the individual's email, the individual's mobile phone number, a VOIP or instant messaging address, etc. Where the entity is a group, the contact information can include the group's post office address, street address, phone number, email, one or more mobile phone numbers, a web page address, a VOIP address or an instant messaging address for the group. Where the entity is a product or service, the contact information can include a post office address, street address, phone number, email address, instant messaging address, VOIP address or other means of contacting a vendor of the product or service.

An attribute can be any characteristic of an entity that can be classified by a multi-level hierarchal arrangement of data having at least three relational levels of hierarchy. Specific attributes will be determined by the provider of the method or system according to the invention and will be determined according to the particular field of human endeavor for which one is interested in providing a searchable database. For example, the context of help-wanted or situation-wanted postings, an industry space will be mapped out, with a first level represented by Industry (e.g. computers, medical, legal, shipping, marketing, sales, child care, etc.) and the second level related to the first level in a category/sub-category relationship. For example, the medical category may include one or more of doctor, nurse, pharmacist, sales, insurance, etc.; the legal category may include litigation, wills & trusts, patents, copyrights, real estate, etc. At least one sub-category, and preferably each, will then be related to a plurality of related attributes. For example, the category/sub-category of “legal/litigation” may have related to it the attributes of paralegal, first chair, second chair, depositions, briefs, document review, etc. In addition to these attributes, there may be other characteristics, such as hourly rates, years of experience, special expertise (such as languages spoken, read, written), etc. In preferred embodiments, each of these characteristics may be back-end driven, i.e. may be selected by the provider of the method or system of the invention. Other embodiments will be apparent to those skilled in the art upon consideration of the description herein and drawings appended hereto.

The entity database is searched using a search engine that is specifically adapted to use search terms from the attribute database. In preferred embodiments, a searcher is permitted (preferably forced) to choose attributes from the attribute database for searching the entity database. In some preferred embodiments, this search engine essentially mirrors the means provided for populating the entity database, except that since the identifying information and contact information are what the searcher is trying to ascertain, the search engine will not normally require the searcher to provide this information. Indeed, in some embodiments, the search engine provides a click-through hierarchal search engine that uses the same hierarchal attribute database to populate search fields, which are then used by the search engine to identify records that contain attribute fields that match the attributes in one or more of the search fields. The search engine thus returns contact information (and in some cases identifying information) from the entity records for which the search engine generates hits.

Some embodiments further provide a computer system or computer-implemented method, wherein the method comprises: (a) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database; (b) receiving registration information including identifying information and contact information for a first entity, and storing said registration information in a registration information field of a record in an entity database; (c) receiving a selection of at least one attribute for the first entity, wherein said at least one attribute is selected from the attribute database; (d) recording the at least one selected attribute in an attribute field in the entity record corresponding to the first entity. In some embodiments, the system or method further comprises: (e) providing to a second entity a search engine adapted to permit the second entity to select at least one attribute from the attribute database; (f) receiving at least one search attribute selected by the second entity from the attribute database; (g) searching the entity database for an entity record containing an attribute that matches the search attribute; and (h) returning entity information for at least the first entity to the second entity. The system and method are adaptable and scalable to a variety of platforms, such as help wanted, situations wanted, social networking, resume listing, product offering and other computer-implemented methods and systems. Specific embodiments of such methods and systems are provided below.

Some embodiments provide a computer system or computer-implemented method, wherein the method comprises: (a) providing an entity database comprising a plurality of entity records, each entity record comprising at least one registration information field populated with registration information for an entity and at least one attribute field corresponding to the entity; (b) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database; (c) providing to a searcher a search engine adapted to permit the searcher to select at least one attribute for which to search from the attribute database; (d) receiving at least one search attribute selected by the searcher from the attribute database; (e) searching the entity database for an entity record containing an entity attribute that matches the search attribute; and (f) providing information for at least the first entity to the searcher. The system and method are adaptable and scalable to a variety of platforms, such as help wanted, situations wanted, social networking, resume listing, product offering and other computer-implemented methods and systems. Specific embodiments of such methods and systems are provided below.

Some embodiments provide a computer system comprising: (a) a multi-level hierarchal database comprising a multi-tier structure having at least three levels, at least one category of the first level being related to a plurality of sub-categories of a second level, and at least one sub-category of the second level being related to a plurality of attributes of a third level; (b) an entity database containing entity records containing registration information fields and attribute fields for a plurality of entities, wherein the attribute fields contain entity attributes selected from the attribute database of (a); (c) a means for receiving registration information and attributes corresponding to a plurality of entities, wherein the attributes must be selected from the multi-level hierarchal database of (a); (d) a means for receiving search information, wherein the search information includes at least one search attribute, and at least one search attribute must be selected from the multi-level hierarchal database of (a); (e) a means for comparing the search information from (d) with the entity attributes corresponding to each of the plurality of entities recorded in the entity database; and (f) a means for displaying the results of the search from (e). The system and method are adaptable and scalable to a variety of platforms, such as help wanted, situations wanted, social networking, resume listing, product offering and other computer-implemented methods and systems. Specific embodiments of such methods and systems are provided below.

The person skilled in the art will recognize that the methods and systems provided herein in are adaptable to a variety of environments and scalable to a variety of sizes. The environment may be of any scale and may be located within a company, a network, a particular region or worldwide. The person skilled in the art will recognize that necessary components of the system will include input/output devices for entering information into the system, one or more servers for handling input/output, a processor adapted to implement the method and sufficient storage for the database(s) as well as sufficient memory. As the method and system of the invention are scalable, the person skilled in the art will be able to recognize the particular scale of resources necessary to implement the methods and systems depending upon the scale and scope of their implementation.

In some embodiments, the methods and systems provided herein will permit efficient collection, storage, searching and dissemination of information relating to facilitating contact between service providers and consumers. In this context a service provider can be a prospective employee (full- or part-time), contractor (or sub-contractor), occasional worker, etc. A consumer can be a prospective employer, a prospective contractee, one looking to engage occasional work, etc. Because the methods and systems of the invention are back-end driven, the structure of the databases being determined before-hand, the methods and systems provided herein allow for efficient searches for individuals or groups meeting particular needs.

In some embodiments, the invention provides a method of facilitating contact between at least one consumer and at least one service provider, comprising: providing a process-oriented task database wherein the tasks are arranged in a multi-level hierarchal arrangement such that a first level is the industry level, an intermediate level is the industry sector, and a final level is the task; receiving service provider registration information including contact information from at least one service provider and recording the at least one service provider's registration information in a service provider database; providing to the at least one service provider a search engine adapted to permit selection of at least one task from the process-oriented task database; receiving from the service provider at least one selection of a task from the process-oriented task database; recording the selected task in the service provider database; providing to the at least one consumer a search engine adapted to permit selection of at least one task from the process-oriented task database; receiving from the at least one consumer a selection of at least one task; comparing the at least one consumer's at least one selected task with the provider's at least one selected task; and, if the consumer's at least one selected task matches at least one provider's at least one selected skill: providing to the at least one consumer contact information for at least one service provider whose at least one selected task matches the consumer's at least one selected task, mediating contact between at least one the at least one consumer and the at least one service provider, or both, wherein the search engines provided to both the service provider and the consumer are hierarchal click-through search engines such that a first level is the industry level, an intermediate level is the industry sector, and a final level is the task. In some embodiments, the search engine adapted to permit selection of at least one task from the process-oriented task database is a hierarchal click-through search engine. In some embodiments, the method further comprises providing to the at least one consumer, the at least one service provider, or both, a work management platform. In some embodiments, the work management platform comprises one or more members of the group consisting of: a contacts list, a references list, a service directory, a service contracts management system, and community information. In some embodiments, the work management platform comprises community information including one or more members of the group consisting of a bulletin board, a community events calendar, a discussion forum, a lost and found and a service rating forum. In some embodiments, the method further comprises providing to at least one consumer, at least one service provider, or both, a community environment comprising a discussion forum. In some embodiments, the discussion forum is arranged by forum topics, a rating forum, or both. In some embodiments, the work management platform comprises a contracting environment adapted to facilitate at least one consumer in making at least one work agreement with at least one service provider. In some embodiments, the contracting environment is adapted to permit at least one consumer, at least one service provider, or both, to perform one or more of the following functions: schedule work appointments, provide reminders of work appointments, enter into work contracts, track work progress, deliver one or more invoices, conduct marketing, submit proposals in a click-through environment or track one or more projects in a click-through environment. In some embodiments, the method further comprises charging a fee to at least one service provider. In some embodiments, the method further comprises charging a registration fee to at least one service provider. The In some embodiments, the method further comprises charging at least one service provider a fee that is based on the number of consumers to whom the service provider's identifying information, contact information, or both, has been provided. In some embodiments, the method further comprises receiving from at least one service provider pricing information for performing at least one task in accordance with the provider's at least one selected task. In some embodiments, the method either comprises recording the pricing information in a database. In some embodiments, the method further comprises providing the pricing information to at least one consumer. In some embodiments, the method further comprises mediating contact between at least one consumer and at least one service provider. In some embodiments, contact is mediated at least in part by providing contact information for at least one consumer to at least one service provider. In some embodiments, the contact information for at least one consumer is transmitted to at least one service provider by one or more of: email, telephone, voice over Internet protocol messaging (VOIP), Internet instant messaging (IM) or wireless text messaging. In some embodiments, the method further comprises charging a fee to at least one consumer. In some embodiments, the method further comprises charging a registration fee to at least one consumer. In some embodiments, the method further comprises charging at least one consumer a basic registration fee or a premium registration fee. In some embodiments, the method further comprises determining whether at least one consumer has been charged a basic registration fee or a premium registration fee; and providing to the at least one consumer identifying information for a first pre-determined maximum number of service providers according to a first pre-determined unit of time if the consumer has been charged the basic registration fee, or providing to the at least one consumer identifying information for a second pre-determined maximum number of service providers according to a second pre-determined unit of time if the consumer has been charged the premium registration fee. In some embodiments, the hierarchal arrangement of tasks comprises at least two levels of organization, including a level corresponding to the industry and a level corresponding to the task. In some embodiments, the hierarchal arrangement of tasks further comprises at least one additional level of organization. In some embodiments, the at least one additional level of organization is selected from an industry sector and a general task category. In some embodiments, the highest (most general) level of organization of the hierarchal arrangement of tasks is the level corresponding to the industry, the intermediate level is the level corresponding to the industry sector level, and the lowest (most specific) level of organization is the level corresponding to task level. In some embodiments, the method further comprises receiving profile data from at least one consumer, at least one service provider, or both. In some embodiments, the method further comprises recording the profile data in a database. In some embodiments, the profile data are received from at least one consumer. In some embodiments, the profile data are received from at least one service provider. In some embodiments, profile data comprise at least one of: a skill set, an experience profile, hobbies, language abilities, and highest level of education attained. In some embodiments, the method further comprises receiving a review of at least one service provider from at least one consumer. In some embodiments, the method further comprises storing the review in a database. In some embodiments, the method further comprises receiving a help request from at least one consumer and providing the help request in a listing viewable by at least one other consumer, at least one service provider or both. In some embodiments, the method further comprises providing to at least one consumer, at least one service provider, or both, at least one of: a service offerings listing and a frequently asked question (FAQ) listing. In some embodiments, the method further comprises: receiving a request for a background check from at least one requester selected from consumers and service providers; and providing a background check report to the at least one requester. In some embodiments, at least one requestor is a consumer and the background check relates to a service provider. In some embodiments, at least one requestor is a service provider and the background check relates to a consumer. In some embodiments, the method further comprises: receiving rating information relating to at least one service provider recording the rating information in a record; receiving from the at least one consumer a list of one or more authorized individuals who may view the rating information; and providing access whereby one or more authorized individuals may view the rating information.

The person skilled in the art will recognize that the methods and systems provided herein may be adapted to an advertising environment. The environment may be of any scale and may be located within a company, a network, a particular region or worldwide. The methods and systems provided herein may be used to advertise goods, services or both. Because the methods and systems of the invention are back-end driven, the structure of the databases being determined before-hand, the methods and systems provided herein allow for efficient searches for individuals or groups meeting particular needs.

In some embodiments, the invention provides a method of advertising a service, comprising: providing to at least one service provider a search engine adapted to permit selection of at least one task from a process-oriented task database wherein the tasks are arranged in a multi-level hierarchal arrangement such that a first level is the industry level, an intermediate level is the industry sector, and a final level is the task; receiving from at least one service provider a selection of at least one task; receiving from the at least one service provider a request to advertise the at least one service provider's selected task; providing to the at least one consumer a search engine adapted to permit selection of at least one task from the process-oriented task database; receiving from the at least one consumer a selection of at least one task; comparing the at least one consumer's at least one selected task with the provider's at least one selected task; and, if the consumer's at least one selected task matches at least one provider's at least one selected skill: transmitting an advertisement on behalf of the service provider to at least one consumer, wherein the search engines provided to both the service provider and the consumer are hierarchal click-through search engines such that a first level is the industry level, an intermediate level is the industry sector, and a final level is the task. In some embodiments, the method further comprises: receiving identifying information and contact information from one or more consumers; and selecting from the consumers a group of consumers to whom the advertising is to be sent In some embodiments, the method further comprises: providing to at least one consumer a search engine adapted to permit selection of at least one task from a process-oriented task database; receiving from the at least one consumer at least one selection of at least one task from the process-oriented task database; recording the at least one selection of at least one desired skill in the process-oriented task database; comparing the service provider's selected task with the consumer's selected task; and when there is a match between the service provider's selected task and the consumer's selected task: assigning the consumer to the group of consumers. In some embodiments, the search engine is adapted to permit selection of at least one task from the process-oriented task database is a hierarchal click-through search engine In some embodiments, the process-oriented task database comprises at least two levels of organization, including a level corresponding to the industry and a level corresponding to the task. In some embodiments, the click-through search engine comprises at least one additional level of organization. In some embodiments, at least one additional level of organization is selected from an industry sector and a general task category. In some embodiments, the highest (most general) level of organization of the hierarchal click-through search engine is the level corresponding to the industry, the intermediate level is the level corresponding to the industry sector, and the lowest (most specific) level of organization is the level corresponding to task. In some embodiments, the search engine is adapted to narrow results by location. In some embodiments, the method further comprises: charging at least one service provider a fee. In some embodiments, the fee is charged on a per-request basis, on a per-unit time basis or on a per-consumer basis.

The person skilled in the art will recognize that the methods and systems provided herein may be adapted to a help-wanted advertising environment. The environment may be of any scale and may be located within a company, a network, a particular region or worldwide. The methods and systems provided herein may be used to advertise goods, services or both. In some embodiments, a help-wanted advertising environment may be an internal environment in which a manager or human resources personnel may seek to identify an individual or group that is suited to carrying out a particular job function, such as staffing a project or performing a contract. In some environments, a help-wanted system can be used by individuals or groups (e.g. households, businesses, schools, government agencies, etc.) to advertise the need for particular skill sets. Because the methods and systems of the invention are back-end driven, the structure of the databases being determined before-hand, the methods and systems provided herein allow for efficient searches for individuals or groups meeting particular needs.

In some embodiments, the invention comprises a method of help-wanted advertising, comprising: providing to at least one consumer a search engine adapted to permit selection of at least one task from a process-oriented task database wherein the tasks are arranged in a multi-level hierarchal arrangement such that a first level is the industry level, an intermediate level is the industry sector, and a final level is the task; receiving from the at least one consumer at least one selected task; receiving from the at least one consumer a request to advertise the consumer's at least one selected task; and providing to the at least one consumer a search engine adapted to permit selection of at least one task from the process-oriented task database; receiving from the at least one consumer a selection of at least one task; comparing the at least one consumer's at least one selected task with the provider's at least one selected task; and, if the consumer's at least one selected task matches at least one provider's at least one selected skill: transmitting an advertisement on behalf of the service provider to at least one consumer, wherein the search engines provided to both the service provider and the consumer are hierarchal click-through search engines such that a first level is the industry level, an intermediate level is the industry sector, and a final level is the task. In some embodiments, the search engine adapted to permit selection of at least one task from the process-oriented task database is a hierarchal click-through search engine. In some embodiments, the process-oriented task database comprises at least two levels of organization, including a level corresponding to the industry and a level corresponding to the task. In some embodiments, the click-through search engine comprises at least one additional level of organization. In some embodiments, at least one additional level of organization is selected from an industry sector and a general task category. In some embodiments, the highest (most general) level of organization of the hierarchal click-through search engine is the level corresponding to the industry, the intermediate level is the level corresponding to the industry sector, and the lowest (most specific) level of organization is the level corresponding to task. In some embodiments, the search engine is adapted to narrow results by location. In some embodiments, the search engine is adapted to narrow results by amount of time the job has been advertised. In some embodiments, the method further comprises: providing to at least one service provider a search engine adapted to permit selection of at least one task from the process-oriented task database; receiving from at least one service provider at least one selected task; and comparing the at least one consumer's selected task with the at least one service provider's selected task. In some embodiments, the search engine adapted to permit selection of at least one task from the process-oriented task database is a hierarchal click-through search engine. In some embodiments, the search engine comprises at least two levels of organization, including a level corresponding to the industry and a level corresponding to the task. In some embodiments, the click-through search engine comprises at least one additional level of organization. In some embodiments, at least one additional level of organization is selected from an industry sector and a general task category. In some embodiments, the highest (most general) level of organization of the hierarchal click-through search engine is the level corresponding to the industry, the intermediate level is the level corresponding to the industry sector, and the lowest (most specific) level of organization is the level corresponding to task. In some embodiments, the method further comprises charging at least one consumer a fee. In some embodiments, the fee is charged on a per-request basis, on a per-unit time basis or on a per-service provider basis.

In some embodiments, the invention comprises a method of facilitating skill set matching in an automated computer environment, comprising: recording a plurality of industry categories; for each industry category, recording a plurality of industry sectors; for each industry sector, recording a plurality of tasks; arranging the plurality of tasks in a process-oriented task database according to industry, industry sector, and optionally one or more additional categories; providing to a service provider a search engine adapted to permit selection of one or more tasks from the process-oriented task database; receiving from the service provider identifying information and at least one selected task; recording the service provider's selected task and the identifying information in a service provider database; providing to at least one consumer a search engine adapted to permit selection of at least one task from the process-oriented task hierarchal task database; comparing the at least one consumer's selected task the at least one service provider's selected task; and, if the at least one consumer's selected task matches the at least one service provider's selected task: providing to the consumer contact information for at least one service provider whose provider skill matches the desired task, mediating contact between at least one the at least one consumer and at least one service provider, or both, wherein the search engines provided to both the service provider and the consumer are hierarchal click-through search engines such that a first level is the industry level, an intermediate level is the industry sector, and a final level is the task. In some embodiments, the search engine adapted to permit selection of at least one task from the process-oriented task database is a hierarchal click-through search engine. In some embodiments, the computer environment is an integrated dispersed network environment. In some embodiments, the integrated dispersed network environment is an intranet, an extranet or a combination thereof. In some embodiments, the extranet is the Internet. In some embodiments, the method further comprises providing to the at least one consumer, the at least one service provider, or both, a work management platform. In some embodiments, the work management platform comprises one or more members of the group consisting of: a contacts list, a references list, a service directory, a service contracts management system, and community information. In some embodiments, the work management platform comprises community information including one or more members of the group consisting of a bulletin board, a community events calendar, a discussion forum, a lost and found and a service rating forum. In some embodiments, the method further comprises providing to at least one consumer, at least one service provider, or both, a community environment comprising a discussion forum. In some embodiments the discussion forum is arranged by forum topics, a rating forum, or both. In some embodiments the work management platform comprises a contracting environment adapted to facilitate at least one consumer in making at least one work agreement with at least one service provider. In some embodiments, the contracting environment is adapted to permit at least one consumer, at least one service provider, or both, to perform one or more of the following functions: schedule work appointments, provide reminders of work appointments, enter into work contracts, track work progress, deliver one or more invoices, conduct marketing, submit proposals in a click-through environment or track one or more projects in a click-through environment. In some embodiments, the method further comprises charging a fee to at least one service provider. In some embodiments, the method further comprises charging a registration fee to at least one service provider. In some embodiments, the method further comprises charging at least one service provider a fee that is based on the number of consumers to whom the service provider's identifying information, contact information, or both, has been provided. In some embodiments, the method further comprises receiving from at least one service provider pricing information for performing at least one task in accordance with the provider's at least one selected task. In some embodiments, the method further comprises recording the pricing information in a database. In some embodiments, the method further comprises providing the pricing information to at least one consumer. In some embodiments, the method further comprises mediating contact between at least one consumer and at least one service provider. In some embodiments, contact is mediated at least in part by providing contact information for at least one consumer to at least one service provider. In some embodiments, the contact information for at least one consumer is transmitted to at least one service provider by one or more of: email, telephone, voice over Internet protocol messaging (VOIP), Internet instant messaging (IM) or wireless text messaging. In some embodiments, the method further comprises charging a fee to at least one consumer. In some embodiments, the method further comprises charging a registration fee to at least one consumer. In some embodiments, the method further comprises charging at least one consumer a basic registration fee or a premium registration fee. In some embodiments, the method further comprises: determining whether at least one consumer has been charged a basic registration fee or a premium registration fee; and providing to the at least one consumer identifying information for a first pre-determined maximum number of service providers according to a first pre-determined unit of time if the consumer has been charged the basic registration fee, or providing to the at least one consumer identifying information for a second pre-determined maximum number of service providers according to a second pre-determined unit of time if the consumer has been charged the premium registration fee In some embodiments the process-oriented task database comprises at least two levels of organization, including a level corresponding to the industry and a level corresponding to the task. In some embodiments, the task database further comprises at least one additional level of organization. In some embodiments, at least one additional level of organization is selected from an industry sector and a general task category. In some embodiments the highest (most general) level of organization of the hierarchal click-through search engine is the level corresponding to the industry, the intermediate level is the level corresponding to the industry sector, and the lowest (most specific) level of organization is the level corresponding to task. In some embodiments, the search engine is adapted to narrow results by location. In some embodiments, the method further comprises receiving profile data from at least one consumer, at least one service provider, or both. In some embodiments, the method further comprises recording the profile data in a database. In some embodiments, the profile data are received from at least one consumer. In some embodiments, the profile data are received from at least one service provider. In some embodiments, the profile data comprise at least one of: a skill set, an experience profile, hobbies, language abilities, and highest education attained. In some embodiments, the method further comprises: receiving a review of at least one service provider from at least one consumer. In some embodiments, the method further comprises storing the review in a database. In some embodiments, the method further comprises receiving a help request from at least one consumer and providing the help request in a listing viewable by at least one other consumer, at least one service provider or both. In some embodiments, the method further comprises providing to at least one consumer, at least one service provider, or both, at least one of: a service offerings listing and a frequently asked question (FAQ) listing. In some embodiments, the method further comprises: receiving a request for a background check from at least one requestor selected from consumers and service providers; and providing a background check report to the at least one requester. In some embodiments, at least one requestor is a consumer and the background check relates to a service provider. In some embodiments at least one requestor is a service provider and the background check relates to a consumer. In some embodiments, the method further comprises: receiving rating information relating to at least one service provider; recording the rating information in a record; receiving from the at least one consumer a list of one or more authorized individuals who may view the rating information; and providing access whereby one or more authorized individuals may view the rating information.

In some embodiments, the invention further comprises a method of facilitating service management, comprising: providing a process-oriented task database, wherein the tasks are arranged in a multilevel hierarchal arrangement such that a first level is the industry level, an intermediate level is the industry sector, and a final level is the task; providing to at least one service provider a search engine adapted to permit selection of one or more skills from the process-oriented task database; receiving from the service provider contact information; receiving from the service provider at least one selected task; receiving from the service provider a rate for each of the at least one selected task; providing to at least one consumer a search engine adapted to permit selection of one or more tasks from the process-oriented task database; receiving from the at least one customer at least one selected task; comparing the at least one customer's at least one selected task with the at least one service provider's at least one selected task; if the at least one customer's at least one selected task matches the at least one service provider's at least one selected task, optionally: providing to the at least one consumer the at least one service provider's contact information; providing the at least one consumer the option to send an offer for engagement to perform the consumer's selected task to the at least one service provider; receiving from the at least one consumer a request to present an offer for engagement to the at least one service provider; and providing the offer for engagement to the service provider; and wherein the search engines provided to both the service provider and the consumer are hierarchal click-through search engines such that a first level is the industry level, an intermediate level is the industry sector, and a final level is the task. In some embodiments, the search engine adapted to permit selection of a task from the hierarchal task database is a click-through search engine. In some embodiments, the method further comprises: providing the at least one service provider with the option to accept the offer of engagement, to propose a counter-offer to the consumer or to reject the offer of engagement; receiving from the at least one service provider an election of the option to accept the offer of engagement, to propose a counter-offer to the consumer or to reject the offer of engagement; and if the at least one service provider elects to accept the offer, transmitting the acceptance to the consumer, thereby forming an agreement for the service provider to perform a service for the consumer; or if the at least one service provider elects to propose a counter offer, receiving terms for a counter offer from the service provider and transmitting the terms of the counter offer to the consumer; or if the provider elects to reject the offer, transmitting a notice of rejection to the consumer. In some embodiments, the method further comprises: receiving from the at least one consumer, the at least one service provider, or both, an indication that the agreed upon service has been completed by the service provider; and generating an invoice from the service provider to the consumer. In some embodiments, the method further comprises: receiving from the consumer, the service provider, or both, an indication that the agreed upon service has been completed by the service provider; providing to the consumer a service provider rating form; and receiving a completed service provider rating from the consumer. In some embodiments, the method further comprises providing the completed service provider rating to the service provider, a third party or both. In some embodiments, the method further comprises providing scheduling assistance to the consumer, the service provider or both.

The inventor has conceived that a multi-leveled hierarchal database may be used to organize other types of data, such as hobby data, for use in a social networking database. Thus, in some embodiments, the invention provides a method of facilitating contact between a first person and a second person, comprising: providing an activity-oriented hobby database comprising a multi-level hierarchal arrangement of activities wherein the activities are arranged in a multi-level hierarchal arrangement such that a first level is the category, an intermediate level is the sub-category, and a final level is the activity; receiving registration information from the first person and the second person and recording the registration information in a contact database wherein the registration information includes contact information, gender, age; and location; providing to the first person a search engine adapted to permit selection of at least one activity from the activity-oriented hobby database; receiving from the first person at least one selection of an activity from the activity-oriented hobby database; recording the selected activity in the contact database; providing to the second person a search engine adapted to permit selection of at least one activity from the activity-oriented hobby database; receiving from the second person a selection of an activity; comparing the second person's selected activity to the first person's selected activity; and, if the first person's selected activity matches the second person's selected activity and optional preferences: providing to the second person contact information for the first person, mediating contact between the first person and the second person, or both; and wherein the search engines provided to both the first person and the second person are hierarchal click-through search engines such that a first level is a category level, an intermediate level is a sub-category level, and a final level is the activity level. In some embodiments, the search engine further comprises the ability to narrow the search by at least one of: age, location, and gender. In some embodiments, the method further comprises providing to the first person, the second person, or both, a contact management platform. In some embodiments, the contact management platform comprises a web log (blog), an electronic mail (email) interface, an instant messaging (IM) interface, a text messaging interface, a voice over internet protocol (VOIP) interface, web-based video interface or other electronic medium interface. In some embodiments, the contact management platform comprises community information including one or more members of the group consisting of a bulletin board, a community events calendar, a discussion forum, a lost and found and a comments forum. In some embodiments, the method further comprises providing to the first person, the second person or both a community environment comprising a discussion forum. In some embodiments, the discussion forum is arranged by forum topics, a rating forum, or both. In some embodiments, the method further comprises charging a fee to the first person, the second person or both. In some embodiments, the method further comprises charging a registration fee to the first person, the second person or both. In some embodiments, the method further comprises charging the first person, the second person or both a periodic fee. In some embodiments, the method further comprises providing advertising to the first person, the second person or both. In some embodiments, the method further comprises collecting an advertising fee from an advertiser. In some embodiments, the fee is charged on a per-display basis, on a per-click basis or both. In some embodiments, the method further comprises mediating contact between the first person and the second person. In some embodiments, contact is mediated at least in part by providing contact information for second person to the first person or for the first person to the second person. In some embodiments, the contact information for the second person is transmitted to the second person by one or more of: email, telephone, voice over Internet protocol messaging (VOIP), Internet instant messaging (IM) or wireless text messaging. In some embodiments, the hierarchal arrangement of activities comprises at least two levels of organization, including a level corresponding to a main category and a level corresponding to the a specific activity. In some embodiments, the hierarchal arrangement of activities further comprises at least one additional level of organization. In some embodiments, at least one additional level of organization is a subcategory. In some embodiments, the highest (most general) level of organization of the hierarchal arrangement of activities is a level corresponding to a main category, the intermediate level is a sub-category, and the lowest (most specific) level of organization is the level corresponding to task level. In some embodiments, the method further comprises receiving profile data from at least person. In some embodiments, the method further comprises recording the profile data in a database. In some embodiments, the profile data comprise at least one of: age, location, gender, a skill set, an experience profile, hobbies, language abilities, and highest level of education attained.

In some embodiments, the invention comprises a method of advertising a product, comprising: providing to at least one service provider a search engine adapted to permit selection of at least one product from a process-oriented product database wherein the products are arranged in a multi-level hierarchal arrangement such that a first level is the industry level, an intermediate level is the industry sector, and a final level is the product; receiving from the at least one service provider at least one selected product; receiving from the at least one service provider a request to advertise the service provider's at least one selected product; and providing to at least one consumer a search engine adapted to permit selection of at least one product from the process-oriented product database; receiving from the at least one consumer a selection of at least one product; comparing the at least one consumer's at least one selected product with the service provider's at least one selected product; and, if the consumer's at least one selected product matches at least one service provider's at least one selected product: transmitting an advertisement on behalf of the service provider to at least one consumer, wherein the search engines provided to both the service provider and the consumer are hierarchal click-through search engines such that a first level is the industry level, an intermediate level is the industry sector, and a final level is the product. In some embodiments, the method further comprises: receiving identifying information and contact information from one or more consumers; and selecting from the consumers a group of consumers to whom the advertising is to be sent. In some embodiments, the method further comprises: providing to at least one consumer a search engine adapted to permit selection of at least one product from a process-oriented product database; receiving from the at least one consumer at least one selection of at least one product from the process-oriented product database; recording the at least one selection of at least one desired product in the process-oriented task database; comparing the service provider's selected product with the consumer's selected product; and when there is a match between the service provider's selected product and the consumer's selected product: assigning the consumer to the group of consumers. In some embodiments, the method further comprises an additional level of organization In some embodiments the highest (most general) level of organization of the hierarchal click-through search engine is the level corresponding to the industry, a first intermediate level is the level corresponding to the industry sector, a second intermediate level is the level corresponding to the activity, and the lowest (most specific) level of organization is the level corresponding to the product. In some embodiments, the activity level comprises the choices: buy, sell, lease, and rent. In some embodiments, the search engine is adapted to narrow results by location. In some embodiments, the method further comprises: charging at least one service provider a fee. In some embodiments, the fee is charged on a per-request basis, on a per-unit time basis or on a per-consumer basis.

In some embodiments, the invention comprises a method of storing and presenting human capital information, comprising: (a) providing a human resource attributes database wherein the database is arranged as a multi-level hierarchy, wherein the hierarchy is divided into at least three levels, and wherein the first level is attribute type, an intermediate level is a sub-category of the attribute type, and a final level is the specific human resource attribute; (b) receiving biographical information from at least one human resource and recording the biographical information the database to create a human resource record; (c) providing a database population application adapted to permit hierarchal selection of at least one attribute type, at least one sub-category of the attribute type, and at least one specific human resource attribute; (d) receiving from a human resource one or more human resource attributes; (e) recording the human resource attributes in one or more human resource attribute fields of the record, wherein each human resource attribute field corresponds to an attribute type; (f) providing a search engine adapted to permit selection from the database of at least one attribute type, at least one sub-category of the attribute type, and at least one specific human resource attribute; (g) comparing the selected human resource attributes to the human resource attributes stored in the records in the database; and if there is a match: (h) providing biographical information for the human resource possessing the desired human resource attribute. In some embodiments, the human resource is an individual. In some embodiments, the human resource is a group. In some embodiments, one or more human resource attributes are arranged in a multi-level hierarchal structure having 2, 3, 4, 5 or more levels, with attribute type representing the highest level of organization. In some embodiments, the search engine is a hierarchal click-through search engine. In some embodiments, the method further comprises providing to the searcher a means for contacting the human resource. In some embodiments, the means for contacting the human resource is: email, telephone, voice over Internet protocol messaging (VOIP), Internet instant messaging (IM) or wireless text messaging.

The present invention is based upon the present inventor's observation that currently available service directories and service management systems, such as on-line yellow pages and consumer-driven contractor listings, often leave the description of the functions that contractors are actually able to perform to either advertisers themselves or to consumers. These descriptions more often from are so general that they leave it to the consumer to directly contact the advertiser and question whether the advertiser has the requisite skill set to perform a particular function for the consumer. As the marketplace increases in size and complexity, this step of screening advertisers is increasingly time-consuming and expensive. Moreover, it leaves the consumer, who is often a lay person with little experience in the contracting realm, at a disadvantage, because the consumer must develop the correct set of questions needed to determine whether the service provider is indeed able to perform the specific tasks that the consumer desires to have performed. The present invention solves this problem by providing, in some embodiments, a task database that contains a detailed listing of the most important skills associated with any given industry. The task database is organized in a hierarchal structure that permits the consumer, using a simple click-through menu-driven search engine to identify those tasks that the consumer desires to have performed. Because the database is also used by service providers to identify the tasks that they are competent to perform (i.e. the skills that they possess), the only answers returned by the consumer-side search engine will be those that match one-to-one at least one of the skills (or optionally all the skills) sought by the consumer. This permits the consumer to screen out service providers in an industry whose skill sets are not in line with the consumer's needs. This, in turn, reduces the amount of time, expense, or both that the consumer is required to expend to make the initial contact with service provider to begin the negotiation process. Additional features of the invention, including work management features, contact-facilitating features, scheduling features, community features, ratings features, background check features and language translation services, add to the functionality of the invention, providing the consumer and the service provider an integrated networking environment for identifying mutually beneficial economic relationships.

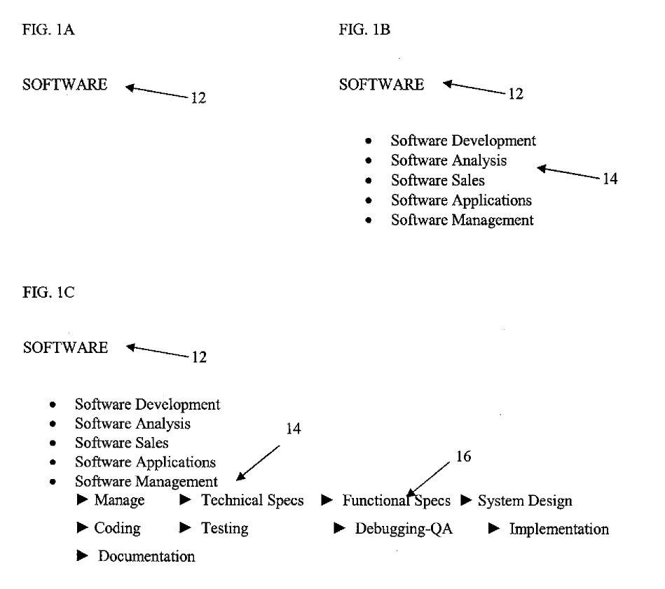

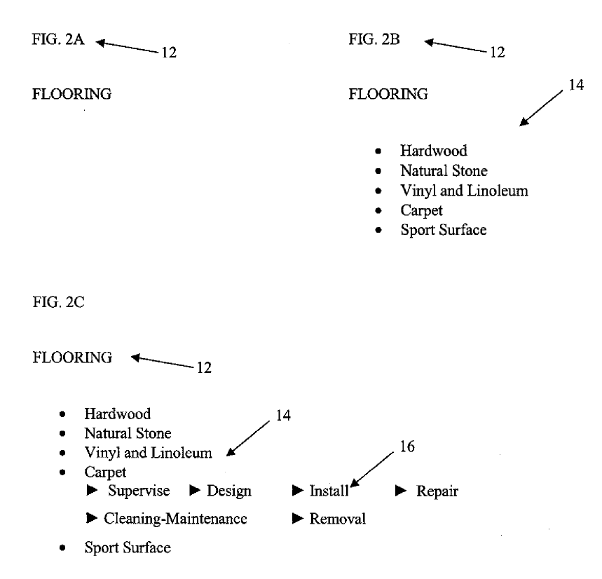

As an example of one illustrative embodiment of the invention, FIGS. 1A-1C depict a hierarchal logical structure for an industry entitled “Software” within a task database, wherein Category 12 (industry) is the highest level of organization. The middle level of organization 14 in FIGS. 1A-1C is the sub-category level, which further divides the Category level in a logical manner. The lowest level of organization 16 is the task (skill) level of organization, wherein each sub-category is divided into process-oriented tasks. For example, under the Category 12 “Software,” one finds the sub-categories 14 Software Development, Software Analysis, Software Sales, Software Applications and Software Management. The sub-category 14 Software Management can then be divided into several tasks 16 (skills), including: Manage, Technical Specs, Functional Specs, System Design, Coding, Testing, Debugging-QA, Implementation and Documentation. In some embodiments, the database further contains a number of years of experience for each task (skill) selected from the list.

Another exemplary process-oriented organizational structure is depicted in FIGS. 2A-2C for the Category 12 “Flooring.” The Category 12 “Flooring,” is divided into several sub-categories 14, including: Hardwood, Natural Stone, Vinyl and Linoleum, Carpet and Sport Surface. The sub-category 14 “Carpet” is further divided into several tasks 16 (skills), including: Supervise, Design, Install, Repair, Cleaning-Maintenance and Removal. In some embodiments, there is associated with each task selected a number of years of experience with that particular type of task.

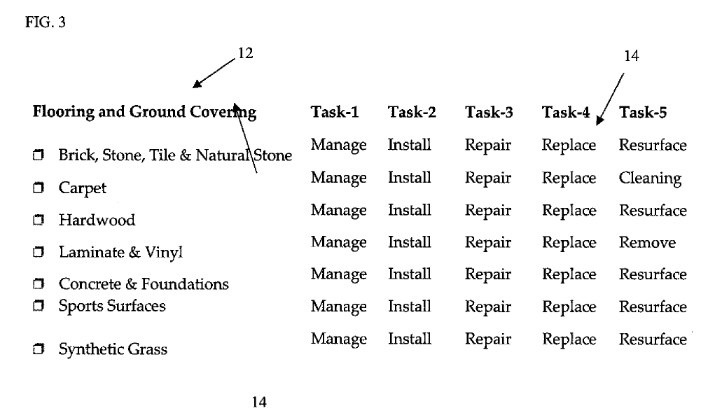

The skills possessed by a service provider, or sought to be contracted by a consumer, can be accessed through a click-through menu, for example as depicted in FIG. 3. In particular, FIG. 3 shows the general layout of a selection screen, in which the Category 12 “Flooring and Ground Covering” is depicted on the left side above the sub-category 14 (e.g. concrete and foundations), with the tasks 16 (skills) belonging to each sub-category 14 located at the right. In some embodiments, a consumer or a service provider will click on at least one applicable skill or task. In some particular embodiments, e.g. when the service provider selects a particular task, the service provider will be prompted (e.g. by drop-down or pop-up screen) to enter a level of experience (e.g. number of months and/or years of experience). In some embodiments, entry of the number of months or years of experience may be forced, meaning that the service provider will have to chose from amongst a menu of months and/or years of service: e.g., 1, 2, 3, 4, 5, 6, 7, 8, 9, 10 or 11 months or 1-2, 2-3, 3-5, 5-10, 1-15, 15-20 or 20 or more years. In some embodiments, a service provider may select more than one skill from the hierarchal database, and may provide additional information, such as experience level, for each of the selected skills.

In some industries, service providers may possess one or more accreditations, degrees, licenses, bonds, or other qualification that may be relevant to whether or not a consumer would choose to consider hiring a particular service provider. In some embodiments, the service provider may specify one or more additional criteria, such as accreditations, degrees, licenses, bonds or other qualifications. In some preferred embodiments, these are stored in a database. In accordance with the invention, this database will be referred to as a criterion database. The service provider may select one or more criteria from the criterion database using a search engine, preferably a click-through search engine or a set of drop down menus. This information is then stored in the service provider database along with the service provider's identifying information and contact information.

In order to identify one or more service providers who possess the particular skills needed by a particular consumer, the consumer searches the task database using a click-through search engine similar to that used by the service provider. (In some embodiments, the search engine may be exactly the same.) The search engine, when used by the consumer, takes the hierarchically organized skills of the task database and populates the fields of a search form (simultaneously or sequentially). This search form is then used by a search engine to query the service provider database, returning information contained in those service provider records that contain the skill or skills that the consumer is seeking.

Upon querying the service provider database, the invention provides the consumer a list of one or more service providers meeting the consumer's task-oriented search criteria. Upon receiving this list, the consumer has a number of options, such as, for example, the following: The consumer can narrow the search by one or more additional criteria; the consumer can contact one or more of the service providers whose contact information is provided by the search engine; the consumer can conduct a new search, specifying different search criteria from the first search.

In embodiments where the service provider has selected additional criteria, such as accreditations, degrees, licenses, bonds, or other qualifications, a consumer may also select one or more criteria, again using a search engine to choose criteria from the criterion database, to use to query the service provider database for service providers possessing consumer-selected criteria, such as accreditations, degrees, licenses, bonds or other qualifications. These consumer-selected criteria are then compared to those stored in the service provider database and the contact information for matching service providers are provided to the consumer.

As can be seen by comparing the method of the present invention with previously known online yellow pages services, the method of the invention differs from yellow pages in that the information contained in the database is organized in a process-oriented manner. Thus, service providers can specify not only which industry they work in, but also the particular skills that they possess—i.e. the particular types of tasks that they typically perform. Consumers can specify not only what type of service provider they are seeking, but which particular tasks the consumer needs to have performed. Service providers are forced to select their skills from the task database; and consumers are forced to select the tasks that they wish to have performed from the same database. In a sense, the method provides both service providers a common lexicon in which to conduct their negotiations. Thus, the method permits service providers to more directly target a subset of consumer who will actually use their particular services and at the same time permits consumers to more directly target that subset of service providers who are competent to perform the tasks that the consumer is seeking to have performed. As noted above, previous methods have required the consumer to directly contact each service provider within an industry category in order to determine whether or not the service provider's skill set matched up with the consumer's needs. Since such contact is time-consuming, and often incomplete, the method of the invention saves time and effort for both consumers and service providers. More directed searching according to the invention also improves service providers' odds of receiving quality contacts.

Further distinguishing it from directories known in the art, the system enables a user to list multiple skill sets across multiple industries with a single registration. This is in contrast to directories known in the art, such as the yellow pages or kudzu, where the user must create a separate listing for each industry. Often, this requires the service provider to create multiple listings in order to represent his full skill set. This increases the costs he must incur to fully represent his skills.

Specific search criteria that the consumer may select, in addition to the task-oriented search criteria, include: the general location of the service provider (county, region, city, zip code, area code, etc.) or proximity to the consumer (e.g. number of miles between the service provider's place of business and the consumer's address); service pricing information; service provider rating or ranking information; language skills possessed by the service provider; etc. In some embodiments, at least some of the additional information can be accessed and specified by a click-through search engine similar to that described above for querying the service provider database. In some embodiments, the consumer may specify one or more search criteria that are not forced.

Thus, the present invention forces both service providers, at least as part of the search process, to select an individualized skill from the hierarchal process-oriented database. The inventor has discovered that this organization of process-oriented search criteria solves the problem of a consumer having to contact multiple service providers to determine whether they are able to perform a specific task. The inventor has accomplished this by analyzing multiple industries, or categories, to determine what specific tasks are most commonly performed by individuals within those industries, and arranging that information into a hierarchy that is easily accessed by a click-through (menu-driven) search engine. The inventor has further found that this approach can be generalized to any industry, whatever its complexity. Thus, the approach used by the inventor differs from previous attempts at organizing service providers by broad industry category, in that the invention allows a consumer to specify that the service provider be able to perform a specific task. Those service providers who do no indicate that they are capable of performing a particular task will be excluded from the consumer's search of the service provider database, thereby saving the consumer the time, effort and expense of contacting multiple service providers who are not capable of satisfying the consumer's needs. This reduces transaction costs for both the consumer, who will not have to speak directly to service providers who cannot satisfy their work needs, and the service providers, who will not have to answer detailed questions from consumers whose needs do not match up with their abilities. This allows the consumer to efficiently skip over a very time consuming part of the search for skilled service providers, thereby allowing consumers and service providers to reach the negotiation stage—i.e. agreeing to price and other contract terms—more efficiently.

In addition to providing a more efficient means of identifying potential service providers, the invention also, in some embodiments, provides one or more additional services that consumers and service providers may find useful for establishing and maintaining business relationships. In some embodiments, for instance, the present invention provides to the consumer an automated engine for letting a service provider know that the consumer is in the market for the service provider's services. In some specific embodiments, the invention provides a messaging tool, which allows the consumer to contact one or more service providers and query them regarding price quotes, availability, scheduling and other details relevant to the contracting process. In some more specific embodiments, the invention provides an automated contact tool that allows the consumer to contact the service provider by one or more methods, such as voice over Internet protocol (VOIP), electronic mail (email), instant messaging (IM) or wireless text messaging. In some embodiments, for example, the invention provides an email environment, wherein the consumer may enter an email text and send it to a service provider's Internet email box. In some such embodiments, the service provider may respond by telephone or by email. In some embodiments, the invention provides an instant messaging service, whereby the consumer may communicate in real time with the service provider via Internet instant messaging. In other embodiments, the consumer may send a text message to the service provider's wireless device (e.g. a cell phone or similar device). The consumer may specify a wireless device for an answer to be sent to; or may specify a telephone number for the service provider to call back. In some embodiments, the invention provides two, three or more of these contact methods.

The invention satisfies the foregoing and related needs by providing a method of facilitating contact between a service consumer (consumer) and a service provider possessing a skill sought by the service consumer. The method includes providing a process-oriented task database comprising a multi-level hierarchal arrangement of tasks. In accordance with the invention, the task database is compiled by analyzing each industry (category) and sector (sub-category) to determine what skills (tasks) are generally possessed (able to be performed) by skilled individuals in the various sectors of the industry. The task database is then organized by industry, each of which industries is sub-divided into sectors, and each of which sectors is broken into skills. The design of this database makes it facile for a click-through search engine (or, in alternate embodiments, a drop-down menu driven search engine) to select particular skills (tasks) from the database based upon industry/sector/skills. Since the service provider uses this database to select the one or more tasks that it is competent to perform (i.e. the service provider's selected task(s)) and the consumer uses the same database to select tasks to be performed (i.e. the consumer's selected task(s)), the method of the invention makes it much easier to identify service providers who actually possess the particular skills necessary to satisfy the consumer's needs. In some embodiments, the method also allows both consumer and service provider to specify an expertise level (e.g. months and/or years of experience), other criteria as described above (e.g. accreditations, licenses, degrees, bonds, etc.), optionally using drop-down or click-through menus. While in some preferred embodiments of the invention, the task database is organized by the analytical method outline above, it is to be understood that in some embodiments the task database may be compiled by any method that provides the type of process-oriented hierarchal database described herein. The method can be implemented using a system comprising at least one server and suitable software provided on said at least one server. Thus, the invention further contemplates a system for implementing the methods described herein, wherein the system comprises one or more servers and suitable software adapted to implement the method.

The method further entails receiving service provider registration information, including contact information, from a service provider and recording the service provider registration information in a service provider database. The method also includes providing to the service provider a hierarchal click-through search engine adapted to permit the service provider to select at least one task from among a plurality of tasks arranged in the task database and receiving from the service provider, via the hierarchal click-through search engine, a selection of a task capable of being performed by the service provider. Once the selected task is recorded in the service provider database as a provider skill, the method entails providing to a consumer a hierarchal click-through search engine for selecting a desired task from the task database and comparing the desired task with the provider skill. Finally, if the desired task matches the provider skill, the method includes providing to the service consumer contact information for the service provider whose provider skill matches the desired task. In some embodiments, the method of facilitating contact between a consumer and a service provider includes receiving from the consumer a request to contact the service provider and contacting the service provider on the consumer's behalf. In particular embodiments, the service provider is contacted via telephone (land line, cell phone or voice over Internet protocol (VOIP)), facsimile, email or wireless text messaging.

In some embodiments, the method according to the invention, especially of the immediately preceding paragraph, further comprises providing to the consumer, the service provider, or both, a work management platform. In some more specific embodiments, the work management platform comprises one or more members of the group consisting of a contacts list, a references list, a service directory, and community information. In some particular embodiments, the work management platform comprises the community information and the community information is provided in a community environment comprising one or more members of the group consisting of a bulletin board, a community events calendar, a discussion forum, a lost and found and a service rating forum. In some more particular embodiments, the community environment comprises a discussion forum arranged by forum topics. In some embodiments, the community environment may comprise a service rating forum, which in some embodiments may include a top ten list, a worst ten list or both. In some embodiments, the work management platform comprises a contracting environment adapted to facilitate consumers in making work agreements with service providers. In particular, the contracting environment may provide a means for scheduling of work appointments, providing reminders of work appointments, engaging a service provider to perform a task for a consumer, tracking of work progress, invoicing, marketing, click-through proposals and click-through project tracking. Such means are well known to those of skill in the art as conventional calendar applications.

In some embodiments, the invention provides a method of facilitating contact between a consumer and at least one service provider possessing a skill sought by the service consumer, such as is described in the foregoing paragraphs, further comprising charging a fee to the service provider, the consumer or both. In some embodiments, the method comprises charging a registration fee to the service provider. In some particular embodiments, the method comprises recording a number of consumers to whom the service provider's contact information has been provided and charging the service provider a fee based on (e.g. proportional to) the number of consumers to whom the service provider's identifying information has been provided.

In some embodiments, the invention provides a method of facilitating contact between a consumer and at least one service provider such as is described in the foregoing paragraphs, further comprising collecting from the service provider pricing information for performing a task and recording the pricing information in the service provider database. In some more particular embodiments, the method further comprises providing the pricing information to the consumer prior to providing the consumer with the at least one service provider's contact information. In some embodiments, the method further comprises receiving from the consumer a request to contact the service provider. In some specific embodiments, the method further comprises transmitting to the service provider a request for contact from a consumer. In some specific embodiments, the request for contact is transmitted via email, telephone, facsimile, voice over Internet protocol messaging (VOIP), Internet instant messaging (IM) or wireless text messaging.

In some embodiments, the invention provides a method of facilitating contact between a consumer and a service provider such as is described in one of the foregoing paragraphs, wherein the method comprises charging a fee to the consumer. In some specific embodiments, the consumer is charged a registration fee and/or a periodic (e.g. yearly or monthly) usage fee. In some particular embodiments, the method comprises determining whether the consumer has been charged a basic registration fee or a premium registration fee; and providing to the consumer identifying information for a first pre-determined maximum number of service providers per pre-determined unit of time if the consumer has been charged the basic registration fee, or providing to the consumer identifying information for a second pre-determined maximum number of service providers per pre-determined unit of time if the consumer has been charged the premium registration fee.

In some embodiments, the invention provides a method of facilitating contact between a consumer and a service provider such as is described in one of the foregoing paragraphs, wherein the task database comprises at least two levels of organization, including a general category of service and specific tasks (skills) within the general category. In some embodiments, the task database further comprises at least one intermediate level of organization between the general category of service and the specific task. In some specific embodiments, the intermediate level of organization is selected from a specific category of service and a general category of skill. In some specific embodiments, the highest level of organization of the process-oriented task database is the major category and the lowest level of organization is a process-oriented task level.

In some embodiments, the invention provides a method of facilitating contact between a consumer and a service provider such as is described in one of the foregoing paragraphs, further comprising receiving profile data from the consumer or the service provider and recording the profile data in a database. In some embodiments, the profile data are received from the consumer and the database in which the profile data are recorded is a consumer database. In some specific embodiments, the profile data are received from the service provider and the database in which the profile data are recorded is a service provider database. In some specific embodiments, the profile data comprise at least one member of the group consisting of a skill set, experience profile, hobbies and language abilities, which belong to the consumer or service provider.

In some embodiments, the invention provides a method of facilitating contact between a consumer and a service provider such as is described in one of the foregoing paragraphs, further comprising receiving a review of a service provider from a consumer and storing the review in a service provider database.

In some embodiments, the invention provides a method of facilitating contact between a consumer and a service provider such as is described in one of the foregoing paragraphs, further comprising receiving a help request from a consumer and providing the help request in a listing viewable by other consumers, service providers or both.

In some embodiments, the invention provides a method of facilitating contact between a consumer and a service provider such as is described in one of the foregoing paragraphs, further comprising providing to a consumer, a service provider, or both, at least one member of the group consisting of a service offerings listing and a frequently asked question (FAQ) listing.

In some embodiments, the invention provides a method of facilitating contact between a consumer and a service provider such as is described in one of the foregoing paragraphs, further comprising receiving a request for a background check from a requestor and providing results of the background check to the requester. In some embodiments, the requestor is a consumer and the background check concerns a service provider. In some embodiments, the requestor is a service provider and the background check concerns a consumer.

In some embodiments, the invention provides a method of facilitating contact between a consumer and a service provider such as is described in one of the foregoing paragraphs, further comprising receiving information regarding a consumer's use of a service provider's services and recording the information in a record; receiving from the consumer a list of authorized individuals who may view the information; and providing access for authorized individuals to view the information regarding the consumer's use of the provider's services.

The invention further addresses the above-cited and related needs by providing a method of advertising the availability of a service, comprising providing to a service provider a hierarchal click-through menu for selecting at least one task capable of being performed by the service provider; receiving from the service provider, via the hierarchal click-through menu a selection of at least one task capable of being performed by the service provider. The task that the service provider is capable of performing can be referred to as a “skill;” and all the skills possessed by a service provider can be conceptualized as the service provider's “skill set.” Once the service provider's skill set has been received, the method continues with receiving from the service provider a request to advertise the service provider's selection of the task capable of being performed by the service provider; and transmitting an advertisement for the service provider to a pre-selected group of consumers.

In some embodiments, the invention provides a method of advertising the availability of a service of the previous paragraph, further comprising: receiving identifying information and contact information from a plurality of consumers; and selecting from the plurality of consumers a group of consumers to receive the advertising. In some more specific embodiments, the method further comprises: providing to each consumer a hierarchal click-through menu for selecting at least one desired skill; receiving from each consumer at least one selection of a desired skill; recording the at least one selection of a desired skill in a database containing the consumer's identifying information; comparing the service provider's skill with the consumer's desired skill; and assigning the consumer to the group of consumers when there is a match between the service provider's skill and the consumer's desired skill. In some embodiments, the method also comprises charging the service provider a fee, which fee may be charged, for example, on a per-request basis (e.g. on the basis of the number of searches performed or the number of answers returned), on a per-unit time basis (e.g. monthly or yearly) or on a per-consumer basis (e.g. per household, per business entity, per proprietor, etc.).

The invention further addresses the foregoing and related needs by providing a method of help-wanted advertising. The method includes providing to a consumer a hierarchal click-through menu for selecting at least one skill desired by the consumer; receiving from the consumer, via the hierarchal click-through menu at least one desired skill; receiving from the consumer a request to advertise the consumer's desired skill; and transmitting a help-wanted advertisement for consumer's desired skill to a pre-selected group of service providers. In some embodiments, the method further comprises: receiving identifying information and contact information from a plurality of service providers; and selecting from the plurality of service providers a group of service providers to receive the advertising. In some specific embodiments, the method further comprises providing to each service provider a hierarchal click-through menu for selecting at least one skill possessed by the service provider; receiving from each service providers at least one selection of a skill possessed by the service provider; recording the at least one selection of a skill possessed by the service provider in a database containing the service provider's identifying information; comparing the consumer's desired skill with the service provider's skill; and assigning the service provider to the group of service providers to receive advertising when there is a match between the consumer's desired skill and the service provider's skill. In some embodiments, the method further comprises charging a fee to the consumer. In some specific embodiments, the fee may be charged on a per-request basis (e.g. per search), on a per-unit time basis (e.g. monthly or yearly) or on a per-service provider basis (e.g. per answer set returned to the consumer or per service provider contacted via the method).

The foregoing and further needs are also addressed by embodiments according to the present invention which provide a method of facilitating skill set matching in an integrated dispersed computer network environment. The method comprises identifying a plurality of work categories; for each work category, identifying a plurality of skills within the work categories; providing a the plurality of skills in a hierarchal database arranged according to work categories; providing to a service provider a click-through search engine adapted to permit the service provider to select one or more skills from the hierarchal database; receiving from the service provider identifying information and at least one selected skill; recording the service provider's selected skill and the identifying information in a service provider database; providing to a consumer a click-through search engine adapted to permit the consumer to select one or more desired skills from the hierarchal database; comparing the selected desired skills with the service provider's selected skill in the service provider database; and providing to the consumer identifying information for a service provider whose skill matches the consumer's desired skill.

The method according to the invention may be implemented on a computer or on a dispersed computer system, such as a local area network or the Internet. In some currently preferred embodiments, the consumer and service provider may each register and use the method from a remote terminal, optionally by way of an internet service portal, it is also possible for the entire system to be contained within a single computer or on a closed network, such as a local area network, for proprietary use by one or more individuals within a closed organization. For example, a hospital might use the method as a management tool to match the skills possessed by nurses and/or other personnel (e.g. respiratory technicians, pharmacists, pharmacy technicians, materials management staff, housekeeping staff and dietary staff), to draft work schedules, especially holiday, emergency or other work schedules. A network of hospitals, which may be related or unrelated business entities, might use the method in a similar way to share temporary, part-time or floater workers between hospitals. A temporary staffing agency might use the method to match available personnel to client needs.

Many businesses find themselves in need of additional services during times of peak usage. For example, the hospitality business tends to be seasonal in nature, with business increasing greatly during particular times of the year. Construction companies often need to contract for services on an as-needed basis. Restaurants, builders, agriculturalists, retailers, manufacturers, textile concerns and information technology businesses often find themselves in need of contractors on a short-term or seasonal basis. Indeed, many such businesses make extensive use of contract labor during periods of peak demand, often engaging the services of tens, hundreds or even thousands of short-term or seasonal laborers. At the same time, households often find themselves in need of occasional, short-term or part time services. Indeed, households often need pool services, gardeners, welders, electricians, housekeepers, care givers, cabinet makers, painters, plumbers, roofers, handymen, cooks, masons and flooring specialists. The present invention provides methods for matching up consumers of particular services, whether individuals, households or businesses, with service providers who possess the necessary skills and experience to meet the consumers' needs. The invention lowers transaction costs between consumers and providers of services by making consumers' searches more efficient. This is accomplished by forcing service providers to describe their capabilities, at least in part, according to the process-oriented hierarchical task database provided by the invention, and by facilitating searches of those descriptions by consumers. Because both consumers and service providers are forced to use the process-oriented hierarchical task database to define their respective needs and skills, consumers are provided with service provider contacts that better meet their needs, thereby reducing the need for consumers to engage in time consuming interviews of service providers within the service or industry sector, many of whom turn out to lack the skills or expertise necessary to satisfy the consumers' needs. Ultimately, by allowing the consumer to narrow the search for suitable service providers to those who possess the specific skills needed by the consumer, the invention allows the consumer to consider a broader spectrum of service providers, thereby increasing the consumer's ability to make a better-informed decision regarding which service providers to contact. At the same time, the methodology of the invention also reduces the need for service providers to field inquiries from customers whose needs to not correspond to the particular skill sets possessed by the service providers.

In some embodiments, the method of the invention will be particularly useful in markets where the numbers of both consumers and service providers is large. For example, the market for occasional or part-time domestic labor is characterized by a large number of consumers (households) and a large number of service providers (individuals). Many times the transaction costs of matching up particular households in need of services with particular individuals willing to perform those services lead to inefficient distribution of labor. One factor that exacerbates this problem is the lack of Internet access by many service providers in the occasional domestic labor market. In some embodiments, the present invention addresses this particular problem by assisting the consumer in contacting the service provider in a number of different ways, including wireless telephone or text messaging. In some embodiments, the invention also provides translation services, background checks, rating services, scheduling and/or billing (invoicing) services. Such services provide both consumers and service providers with additional aid in evaluating potential business relationships. Such features tend to lower the transaction costs in temporary or part-time contracting, thereby providing for more efficient use of these markets by consumers and service providers alike.

It is contemplated that embodiments of the invention can be implemented in a dispersed network environment, such as the Internet or an intranet. In one such implementation, the task database, consumer database, service provider database and search engine are hosted on a server that is connected to the Internet. Access to the invention is provided by a “host,” which establishes, maintains and operates the system on which the methods are executed. In some preferred embodiments, providers and consumers may access the server via the Internet, although other embodiments are contemplated. For example, in some embodiments, the host may permit access to the invention by having consumers, service providers or both call in to a human operator who then performs the necessary steps to use the methods on behalf of the consumers and/or service providers.

The foregoing and further needs are also addressed by embodiments according to the present invention which provide a method for facilitating contact between a first person and a second person. In this context, reference is made to “a first person” and “the first person” for the sake of convenience, although more than one person may use the system and method to facilitate contact with another person with whom to communicate in a social networking environment. Thus “a first person” is not intended to mean “one and only one first person,” but rather “at least one first person” (unless otherwise clearly specified). The same is true of “a second person,” in that more than one person may use the method and system of the invention to provide their contact information in a searchable database for the purpose of social networking. Thus, “a second person” is not intended to mean “one and only one second person,” but rather, “at least one second person” (unless otherwise clearly specified.) Thus, unless otherwise clearly specified, the invention permits a plurality of persons to provide contact information, including specific hobby information; and the invention further permits a plurality of persons to search said database making use of a hierarchal search tool. In some embodiments, the system comprises a server comprising a processor, memory, storage, input-output devices and software adapted to receive data and search queries from the persons using it. In some embodiments, a person can include either a natural person or a legal person, such as a partnership (in fact or de jure), a corporation, a company or other legal person.

Embodiments of the invention provide a method comprising providing an activity-oriented hobby database comprising a multi-level hierarchal arrangement of activities. The multi-level hierarchal arrangement of activities can take numerous forms so long as there is a hierarchal relationship between at least two of the levels of arrangement. In some embodiments, the hierarchal arrangement comprises at least a first “category” level and a second “activity” level. In some embodiments, the hierarchal arrangement comprises a first “Main Category” level, a second “Sub-Category” of arrangement and a third “Activity” arrangement. A person using the database selects first a main category from a plurality of Main Category selections (i.e. 2 or more selections). Each main category has associated with it, and subordinate to it, a plurality of sub-categories, which are selected from the Sub Category selections. Each sub category, in turn, has associated with it, and subordinate to it, a plurality of activities, which can be selected from the Activity selections. The main categories, sub-categories and activities may be thought of as being arranged in a hierarchal tree in which each main category forms a base of a main branch from the tree and each activity forms a stern, with each sub-category representing a subsidiary branch of a main branch and having multiple stems. A system according to the invention thus comprises storage for storing the hierarchal database, as well as input/output devices, a processor, memory and software adapted to create, maintain and update the hierarchal database.

The method and system according to the invention are adapted to receive registration information including contact information from said second person and recording the second person's registration information in a contact database. The contact database is adapted to hold information peculiar to the second person, at least some of which information may be of interest to another person seeking to establish a social networking relationship with the second person. Such other information may include the second person's name, physical address, mailing address, email address, web site, instant messaging address, telephone number (home, work, mobile, VOIP, etc.) or other address. Other information may also include additional information that is not to be made public, such as billing information. In preferred embodiments, the contact database contains at least one activity that the second person selects from the hierarchal database described above, preferably with the use of a hierarchal click-through menu-driven search engine. In some embodiments, the second person may populate his or her contact information with 1, 2, 3, 4 or more activities selected from the hierarchal database. In some embodiments, the system of the invention includes storage, memory, a processor, input/output devices and software adapted to implement the database described herein.

Thus the method and system according to the invention are adapted to provide to the second person a search engine adapted to permit selection of at least one activity from the activity-oriented hobby database. As mentioned above, the activity-oriented hobby database is a hierarchal database. In some preferred embodiments of the invention, the method and system allow the second person to select one or more activities from the activity-oriented hobby database using a hierarchal click-through search engine. In some particularly preferred embodiments, the hobby database is organized into at least two levels, preferably at least three levels, which levels arc hierarchal. The method and system of the invention thus are adapted to receive from the second person at least one selection of an activity from the activity-oriented hobby database and to record the selected activity in the contact database. Some embodiments thus provide a system that includes storage, memory, a processor, input/output devices and software adapted to implement the search engine and contact database described herein.

A method and system according to the invention are adapted to provide to the first person a search engine adapted to permit selection of at least one activity from the activity-oriented hobby database, to receive from the first person a selection of an activity and to compare the first person's selected activity to the second person's selected activity. In this regard, it is again noted that while reference is made to “a” or “an” activity, this is not intended to exclude the possibility of there being more than one such activity selected by one or more first persons, one or more second persons or both. Some embodiments thus provide a system that includes storage, memory, a processor, input/output devices and software adapted to implement the search engine and contact database described herein.

If the first person's selected activity matches the second person's selected activity, a method or system described herein provides to the first person contact information for the second person, mediates contact between the first person and the second person, or both. Some embodiments thus provide a system that includes storage, memory, a processor, input/output devices and software adapted to implement the search engine and contact database described herein.

In some embodiments, the search engine is adapted to permit selection of at least one activity from the activity-oriented bobby database is a hierarchal click-through search engine. Some embodiments thus provide a system that includes storage, memory, a processor, input/output devices and software adapted to implement the hierarchal click-through search engine described herein.

In some embodiments, the method further comprises providing to the first person, the second person, or both, a contact management platform. In some embodiments, the contact management platform comprises a web log (blog), an electronic mail (email) interface, an instant messaging (IM) interface, a text messaging interface, a voice over internet protocol (VOIP) interface, web-based video interface or other electronic medium interface. In some embodiments, the contact management platform comprises community information including one or more members of the group consisting of a bulletin board, a community events calendar, a discussion form a lost and found and a comments forum. In some embodiments, the method further comprises providing to the first person, the second person or both a community environment comprising a discussion forum. In some embodiments, the discussion forum is arranged by forum topics, a rating forum, or both. Some embodiments thus provide a system that includes storage, memory, a processor, input/output devices and software adapted to implement the contact management platform. Some embodiments thus provide a system that includes storage, memory, a processor, input/output devices and software adapted to implement a blog, email, IM, text messaging, VOIP, video conferencing, etc.

In some embodiments, the method further comprises charging a fee to the first person, the second person or both. In some embodiments, the method further comprises charging a registration fee to the first person, the second person or both. In some embodiments, the method further comprises charging the first person, the second person or both a periodic fee. The fee may be billed on a standard invoice or may be extracted from a pre-established account, such as a credit card account or a debit card account. Some embodiments thus provide a system that includes storage, memory, a processor, input/output devices and software adapted to implement the fee charging system.

In some embodiments, the method further comprises providing advertising to the first person, the second person or both. In some embodiments, the method further comprises collecting an advertising fee from an advertiser. In some embodiments, the fee is charged on a per-display basis, on a per-click basis or both. Some embodiments thus provide a system that includes storage, memory, a processor, input/output devices and software adapted to implement the advertising and/or the fee-charging. The fee may be billed on a standard invoice or may be extracted from a pre-established account, such as a credit card account or a debit card account.

In some embodiments, the method further comprises mediating contact between the first person and the second person. In some embodiments, the contact is mediated at least in part by providing contact information for second person to the first person or for the first person to the second person. In some embodiments, the contact information for the second person is transmitted to the second person by one or more of: email, telephone, voice over Internet protocol messaging (VOIP), Internet instant messaging (IM) or wireless text messaging. Some embodiments thus provide a system that includes storage, memory, a processor, input/output devices and software adapted to implement the method of mediating contact between the first person and the second person.

As discussed above, the activity-oriented hobby database is a hierarchal arrangement of activities. In some embodiments, the hierarchal arrangement of activities comprises at least two levels of organization, including a level corresponding to a main category and a level corresponding to the a specific activity. In some embodiments, the hierarchal arrangement of activities further comprises at least one additional level of organization. In some embodiments, the at least one additional level of organization is a sub-category. In some embodiments, the highest (most general) level of organization of the hierarchal arrangement of activities is a level corresponding to a main category, the intermediate level is a sub-category, and the lowest (most specific) level of organization is the level corresponding to task level. Some embodiments thus provide a system that includes storage, memory, a processor, input/output devices and software adapted to implement the activity-oriented hobby database.

In some embodiments, the method further comprises receiving profile data from at least person. In some embodiments, the method further comprises recording the profile data in a database. In some embodiments, the profile data comprise at least one of: a skill set, an experience profile, hobbies, language abilities, and highest level of education attained. In some embodiments, the invention provides a system adapted to implement the described method, wherein the system comprises at least one server and software adapted to implement the method. The at least one server comprises storage for the databases, inputs and outputs for receiving and transmitting data, a processing unit and memory for running the software adapted to implement the method described herein. Some embodiments thus provide a system that includes storage, memory, a processor, input/output devices and software adapted to implement the collection, storage and presentation of profile data.

The invention further addresses the above-cited and related needs by providing a method of advertising the availability of a product, comprising providing to a service provider a hierarchal click-through menu for selecting at least one product capable of being provided by the service provider; receiving from the service provider, via the hierarchal click-through menu a selection of at least one product capable of being provided by the service provider. Once the service provider's product has been received, the method continues with receiving from the service provider an indication of how he wishes to provide the product: sell, rent, or lease. Once this information has been received, the method continues with a request to advertise the service provider's selection of the product capable of being provided by the service provider; and transmitting an advertisement for the service provider to a pre-selected group of consumers.

In some embodiments, the invention provides a method of advertising the availability of a product of the previous paragraph, further comprising: receiving identifying information and contact information from a plurality of consumers; and selecting from the plurality of consumers a group of consumers to receive the advertising. In some more specific embodiments, the method further comprises: providing to each consumer a hierarchal click-through menu for selecting at least one desired product; receiving from each consumer at least one selection of a desired product; recording the at least one selection of a desired product in a database containing the consumer's identifying information; comparing the service provider's product with the consumer's desired product; and assigning the consumer to the group of consumers when there is a match between the service provider's product and the consumer's desired product. In some embodiments, the method also comprises charging the service provider a fee, which fee may be charged, for example, on a per-request basis (e.g. on the basis of the number of searches performed or the number of answers returned), on a per-unit time basis (e.g. monthly or yearly) or on a per-consumer basis (e.g. per household, per business entity, per proprietor, etc.).

The invention further addresses the above-cited and related needs by providing a method of storing and searching for human resource attributes. The hierarchal click-through data storage and search strategy described herein can be used by an organization as a management tool for quickly and easily matching skill sets and other attributes of a human resource to a skill set that a manager may need to complete a particular job or fill a position in his permanent workforce. A human resource includes an individual or a group. Traditionally, a manager seeking personnel to carry out a particular task, job or work function might have to rely on dispersed information, such as resumes or personnel records, to determine whether or not an individual or group would be able to perform the task, job or work function. This leads to several problems, amongst them being that a manager must read voluminous quantities of text in order to obtain relevant information, the text provided to the manager may lack information relevant to the task at hand and the manager may miss information that is hidden in the dispersed sources of information.

Some embodiments solve this problem by providing a method of storing and presenting human capital information, comprising: (a) providing a human resource attributes database wherein the database is arranged as a multi-level hierarchy, wherein the hierarchy is divided into at least three levels, and wherein the first level is attribute type, an intermediate level is a sub-category of the attribute type, and a final level is the specific human resource attribute; (b) receiving biographical information from at least one human resource and recording the biographical information the database to create a human resource record; (c) providing a database population application adapted to permit hierarchal selection of at least one attribute type, at least one sub-category of the attribute type, and at least one specific human resource attribute; (d) receiving from a human resource one or more human resource attributes; (e) recording the human resource attributes in one or more human resource attribute fields of the record, wherein each human resource attribute field corresponds to an attribute type; (f) providing a search engine adapted to permit selection from the database of at least one attribute type, at least one sub-category of the attribute type, and at least one specific human resource attribute; (g) comparing the selected human resource attributes to the human resource attributes stored in the records in the database; and if there is a match: (h) providing biographical information for the human resource possessing the desired human resource attribute.

As used herein, human capital information includes information on one or more human resources. It comprises identifying information and at least one human resource attribute for each human resource. A multi-level hierarchy includes a highest level, referred to as “attribute type,” and at least one human resource attribute under each attribute type. The human resource attributes are entered into records in the human capital database using the multi-level hierarchal attributes database. The human capital database is searched using a search engine. The search engine is pre-populated with search terms describing attribute types and human resource attributes in the database. In preferred embodiments, the human resource attributes are selected by choosing an attribute type from the hierarchal database and then choosing one or more human resource attributes organized under the selected attribute type. Once the search terms are chosen, the search is conducted by comparing the selected human resource attributes to the human resource attributes stored in the records in the human capital database. If there is a match, the biographical information for the human resource possessing the desired human resource attribute is returned and displayed for viewing.

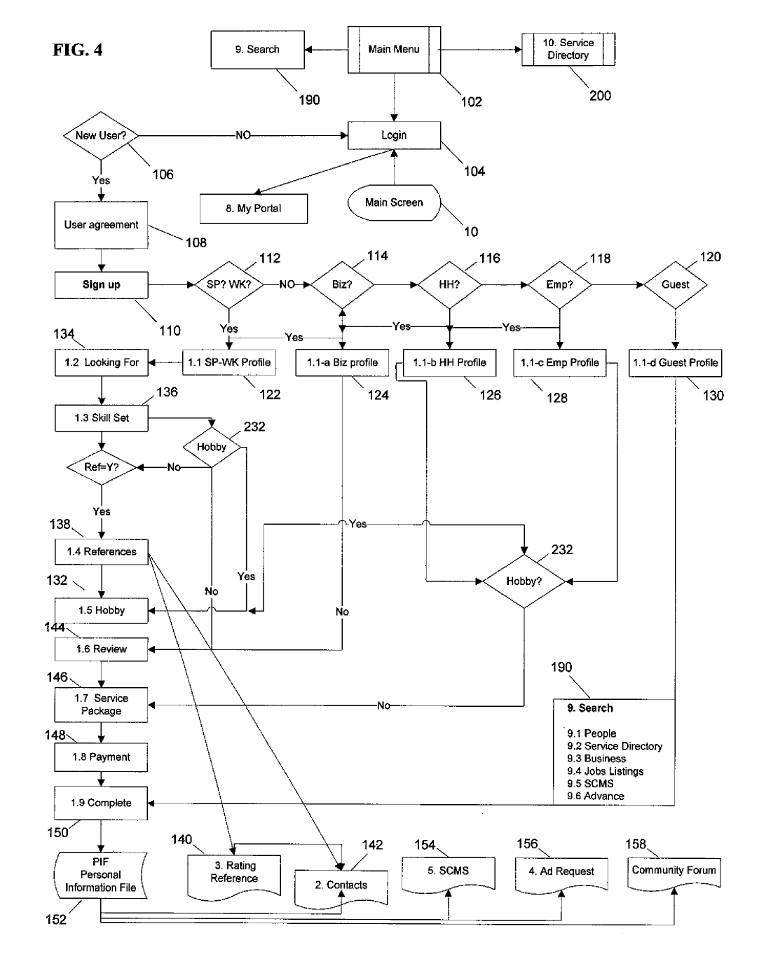

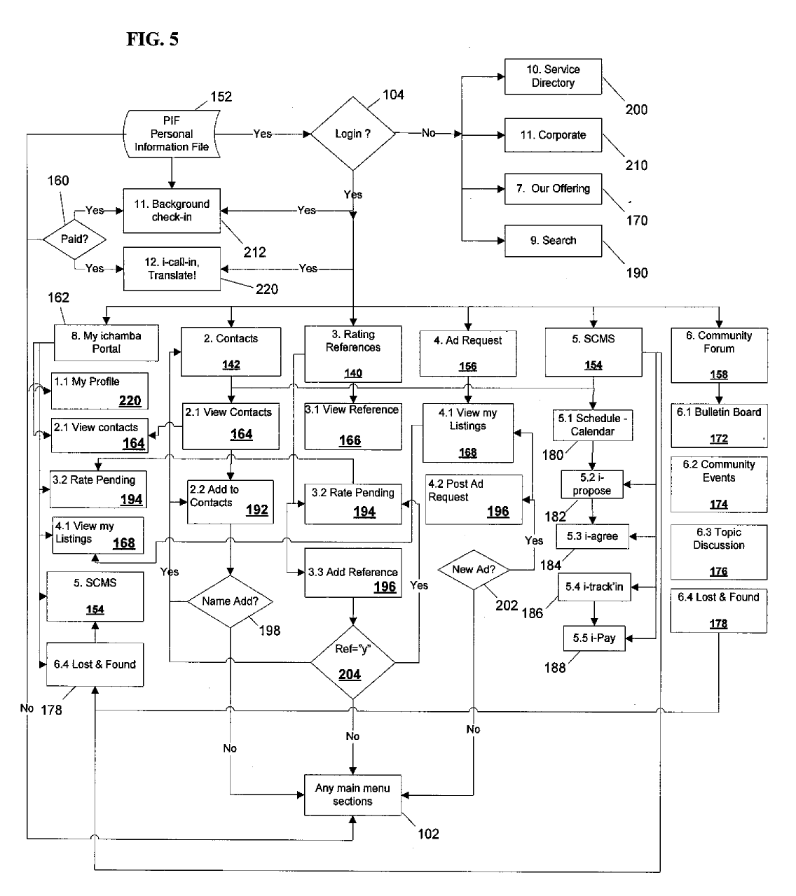

Flowcharts for exemplary embodiments of the system according to the present invention are provided in FIGS. 4 and 5, the former of which shows how a new user registers to use the system and completes the user profile and the latter of which provides a high-level flow chart for remaining functions of the system.

It should be noted that, in some embodiments, the focus of the system according to the present invention is on the skills possessed by an individual, not an organization. (In other embodiments an organization may be registered as an individual). Thus, a business may register one or a plurality of individuals, each of whom is identified as a separate service provider, using the system of the invention. A consumer then searches the service providers (individuals or organizations) to select the service provider having the particular skill set needed by the individual.

The invention makes use of a database referred to herein as a task database, which is organized by industry (category), sector (sub-category) and skill (task) in a hierarchal structure, which emphasizes the functions (tasks) that represent each individual's expertise. Both consumers and service providers use this database to contact one another. A service provider specifies the service provider's skill set by selecting specific skills from the task database using a hierarchal click-through search engine. The service provider selects an industry (category), which opens a list of sectors (sub-categories), from which the service provider may select one or more skills. In some embodiments, the service provider may specify a level of expertise (represented by months or years of experience in a particular skill). In some specific embodiments, the service provider selects the level of expertise by way of drop down menus. The selected skills and, if applicable, expertise levels, are stored in a database along with the service provider's contact information. A consumer can then search the database using a hierarchal click-through search engine that permits the consumer to select specific expertise needed for the consumer's project by clicking an industry, which opens a selection of sectors (sub-categories), from which the consumer may check one or more skills needed for a project. In some embodiments, the consumer may also indicate a level of expertise (represented by a number of months or years) that the service provider must possess. In some specific embodiments, the level of expertise may be selected by drop-down menus. In any case, the consumer's selected skills are then used by the search engine to search the service provider database and identify those service providers who possess the skills and experience desired by the consumer.

Turning to FIG. 4, a user accesses the Main Screen 10 via the Internet, an intranet (i.e. a closed network such as a LAN) or other computer environment in a conventional manner. In the context of this example, “user” can mean either consumer or service provider, depending upon whether the user is seeking to purchase services or sell services. Indeed, the same user may be either a consumer or a service provider, respectively, depending on the particular situation. The embodiment outlined in the flow chart of FIG. 4 will permit a user to register as a consumer, as a service provider, or both. For example, a sub-contractor may utilize the invention to advertise the sub-contractor's skills as a sub-contractor to general contractors, and to find individuals capable of performing certain tasks specific to the job requirements of a particular client.

The Main Screen 10 may contain identifying information for the host, such as the host company's logo and contact information, link to an information section, a FAQ page, a user comment page, etc. In addition, Main Screen 10 includes a link to a log-in page 104, whereby the user may access and utilize the methods of the invention. The logical operator “New User” 106 indicates that the user is queried as to whether the user is a new user or a registered user. A “yes” response to this query results in the user being redirected to a User Agreement page 108. After the user has indicated that the User Agreement 108 has been read and agreed to, the user is directed to a Sign Up page 110, where the user fills out an application form, including such identifying and contact information as may be needed by the host. After providing this sign in information, the user indicates whether the user is signing up as a Service Provider 112, a Business 114, a Household 116, an Employee 118 or a Guest 120. If the user registers as a Guest 120, the user is redirected to a Guest Profile page 130, where the user may perform a search using a Search Engine 190. If the user selects any of Service Provider 112, Business 114, Household 116 or Employee 118, the user is then redirected to a profile entry page: Service Provider Profile 122, Business Profile 124, Household Profile 126 or Employee Profile 128. The profile pages 122, 124, 126 and 128 permit the user to specify specific skills by selecting those skills from the task database as described above. In some currently preferred embodiments, the user selects those skills from the task database using a search engine that permits the user to select an industry (category), which provides a sector (sub-category) list, from which specific skills (tasks) may be selected. In particular embodiments, the user can also specify levels of expertise for each skill (measured in months or years), especially using drop down menus.

The Household Profile page 126 and the Employee Profile page 128 also allow the user to specify a hobby, if applicable. If a hobby is selected (Yes) the user is redirected to a Hobby page 132. If no hobby is selected, the Hobby decision point 232 redirects the user to choose a Service Package 146. After a Service Package 146 is selected, the user is then directed to a Payment page 148. Once the payment process is Complete 150, the user is directed to a PIF (Personal Information File) page 152, which allows the user to access a variety of services available to the user. For example, the user may access a Contacts page 142, which directs the user to a Rating Reference page 140. The user may also choose to access the SCMS page 154, the Ad Request page 156 or the Community Forum 158. These choices will be discussed in greater detail herein.

A user who selects the Business Profile 114 is directed to a Business Profile page 124, the user skills from the task database using a search engine that permits the user to select an industry (category), which provides a sector (sub-category) list, from which specific skills (tasks) may be selected. In particular embodiments, the user can also specify levels of expertise for each skill (measured in months or years), especially using drop down menus. Once the Business Profile 124 is completed, the user is directed to a Review page 144. Once review is completed, the user may select a service package at the Service Package page 146. After a Service Package 146 is selected, the user is then directed to a Payment page 148. Once the payment process is Complete 150, the user is directed to a PIF (Personal Information File) page 152, which allows the user to access a variety of services available to the user. For example, the user may access a Contacts page 142, which directs the user to a Rating Reference page 140. The user may also choose to access the SCMS page 154, the Ad Request page 156 or the Community Forum 158. These choices will be discussed in greater detail herein.

A user who selects the Service Provider option 112 is directed to a Service Provider Profile page 122. The user is directed to a Looking For page 134, where the user specifies what type of work the Service Provider is seeking to perform. The user is then directed to a Skill Set page 136, where the user specifies specific skills possessed by the user by selecting those skills from the task database as described above. The user is also given the option of providing references, and if such references are to be provided (Ref=Y), then the user is directed to a References page 138, where the user can provide information for contacting references at the Contacts page 142 and the Rating Reference page 140 (which are described in more detail herein). The user is next redirected to the Hobby decision step 232. If the user wishes to enter hobby information, the user is directed to the Hobby page 132. Once the user has entered the hobby information, the user is directed back to the Hobby decision step 232, which directs the user to the Review page 144. Once review is completed, the user may select a service package at the Service Package page 146. After a Service Package 146 is selected, the user is then directed to a Payment page 148. Once the payment process is Complete 150, the user is directed to a PIF (Personal Information File) page 152, which allows the user to access a variety of services available to the user. For example, the user may access a Contacts page 142, which directs the user to a Rating Reference page 140. The user may also choose to access the SCMS page 154, the Ad Request page 156 or the Community Forum 158. These choices will be discussed in greater detail herein.

A user may complete a Looking For screen 136, which permits the user to specify as skill set 136 using a click-through search engine as described above. The user may also provide references using the References function 138, whereby the user may make use of the Rating screen 140, the Contacts screen 142 or both. The user may also review the provided profile information or “looking for” information at the Review screen 144, choose a service package at Service Package screen 146, pay for the service package (e.g. by PayPal, credit card, ATM card, debit card, etc.). Once the registration process is complete at the Complete page 150, the user's information is stored in the user's Personal Information File 152. The user may then progress on to the Rating Reference screen 140, the Contacts screen 142, the SCMS 154, the Ad Request screen 156 or the Community Forum 158.

Continuing on with FIG. 5, the user may log in at the Login screen 104. If the user chooses not to log in, the user is directed to a page where the user may select a Service Directory 200, access to Corporate data 210, an “Our Offering” site 170, which provides information on the services provided by the system according to the invention and a Search page 190. If the user chooses to long in, the user's personal login ID and password are confirmed against the Personal Information File 152 and the system then verifies that the user has paid 160. The user may also access a translator 220 or a background check function 212. The user may also select from amongst the selections in the main menu, i.e. My Portal 162, which permits the user to view the user's profile, contacts, pending request for ratings, listings, SCMS and lost and found. The user may also directly enter Contacts 142, provide and review Rating References 140, make an Ad Request 156, enter the SCMS (Service Contract Management System) 154 or enter the Community Forum 158.

The Community Forum 158 allows the user to view and/or make additions to the Bulletin Board 172 the Community Events calendar 174, the Topic Discussion board 176 and/or the Lost & Found board 178. The Ad Request 156 permits one to create an advertisement for services, edit an existing advertisement, view existing advertisements, etc. The Rating References 140 permits the user to create reference ratings for service providers, view reference ratings for service providers that are listed by themselves or other users, etc. The Contacts page 142 allows the user to keep a contacts database, which may be shared with other users at the user's option.

The Service Contract Management System (SCMS) 154 facilitates the entry into service contracts by two or more users. In this case, there must be at least two users, each of whom has already registered as described above. A first user, called the service provider, indicates which skills are possessed by registering the service provider's skill set using the method described above—i.e. selecting the skills from the task database using the click-through search engine. The second user, called a consumer, has also registered, specifying “looking for” information using the same task database as the source of search terms to search the service provider's personal information file for matching skills. Once the consumer has performed the search, and identified a service provider, the consumer may check the service provider's schedule using the Schedule-Calendar 180. The consumer may then select services desired, the rates that the consumer is willing to pay for the service, and scheduling information form the i-Propose page 182. In currently preferred embodiments, this i-Propose page 182 is a menu driven form from which the consumer may select each of the specified criteria. Once the i-Propose page 182 form has been completed, it is forwarded to the service provider. If the service provider agrees to the specified terms, the service provider may simply click through the I Agree page 184, which sends an acceptance notice to the consumer. If the service provider disagrees with any of the terms of the proposal, the service provider may send to the consumer a counter proposal. The service provider and consumer may then continue to counter-propose until both agree on the terms on which the service will be provided. In some currently preferred embodiments, the proposal and counter-proposal process is carried out by means of click-through forms, wherein most terms, such as tasks to be performed (skills), pricing (rates) and timing (schedule) may be completed by drop-down menus and further terms may be provided by either drop-down menus, fill in boxes, or both. Once a proposal by one user has been accepted by the other user, the agreement has been made. The users may then track and update the progress of the agreed-upon project using the i-track-in page 186. In some currently preferred embodiments, the i-track-in page 186 is a menu-driven form, on which the consumer and service provider may each indicate when the service provider has completed the agreed-upon work. In some embodiments, once the consumer indicates that the work has been completed, the consumer is prompted to rate the service provider's performance. In some particularly preferred embodiments, this rating is accomplished by filling out a form using click-through and drop down menus. In any case, once the consumer and the service provider have both indicated that the work is complete, the service provider is directed to the i-Pay screen 188, whereby the service provider may generate an invoice, which is sent to the consumer. The service provider may track whether or not the service provider has been paid, may collect electronic payment or both using the i-Pay 188 feature.

It is noted that, while this is a currently preferred embodiment of the invention, it is also possible for service providers, consumers or both to fill out an application via a different medium, such as toll-free (1-800) telephone service or traditional postal service.

The Ad Request function 156 allows a user to place an advertisement for a service: either a help wanted advertisement or a service available advertisement. The Ad Request function 156 includes a View my Listings function 168 and a Post Ad Request 196 function. Using these functions, a user may broadcast an advertisement for help wanted or services provided to a group of users, the scope of which group may be limited by geographic region, demographic group or other criteria, as discussed in more detail herein.

The Rating References function allows the user to View References 166, Add References 196, view Rate Pending status requests 194.

The Contacts page 142 allows the user to View Contacts 164 and/or Add Contacts 192. The Name Add function 198 allows the user to add contacts to the user's contacts list.

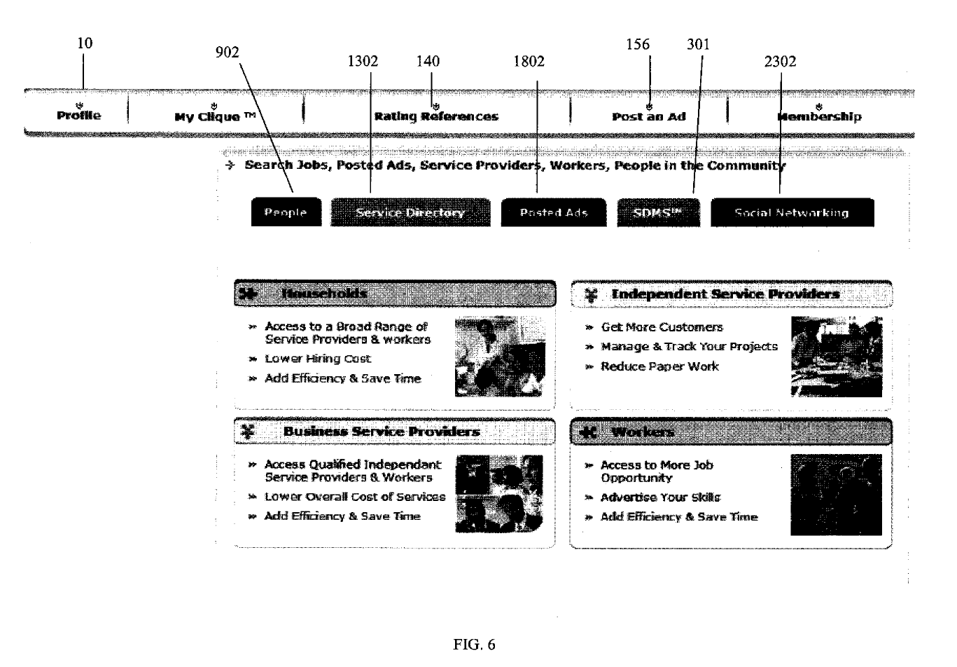

Screenshots of embodiments of the system according to the present invention are provided in FIGS. 6 though 32. FIG. 6 is an embodiment of the Main Page 10 of the invention. There is a link to the Rating References page 140. There is a link to the page where one can Post an Ad 156. It also possesses links to the various search pages: People 902, Service Directory 1302, Posted Ads 1802, SCMS (in this embodiment it is called SDMS Service Directory Management System) 301, and Social Networking 2302.

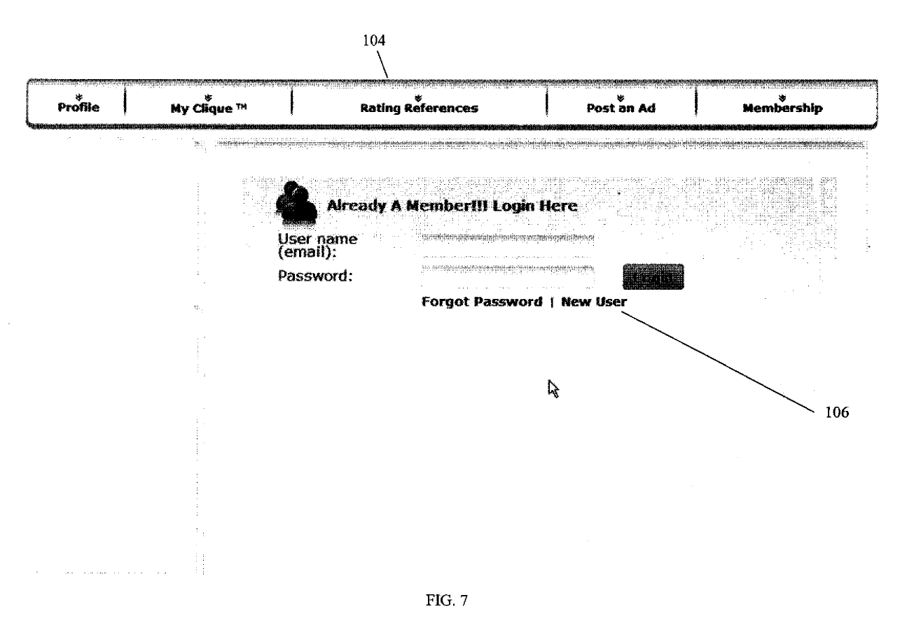

FIG. 7 is an embodiment of the Login Page 104. It possesses the New User logical operator 106.

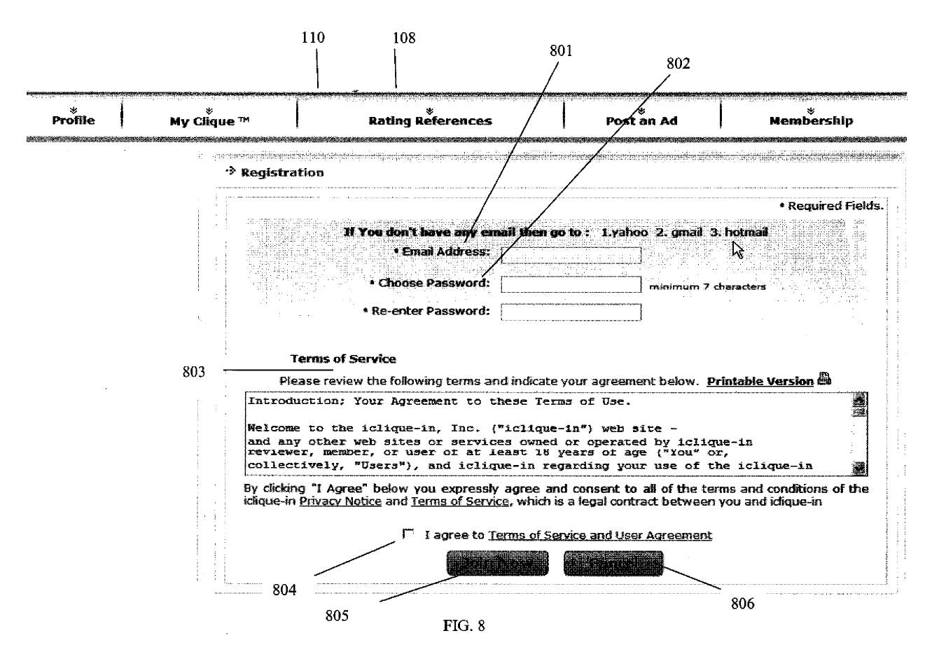

FIG. 8 is an embodiment of both the Sign Up page 110 and the User Agreement page 108. To sign up, one enters their email address 801 and a password 802. One then reads the Terms of Service 803, indicates their assent to the Term of Service by checking the box 804, and clicks the Join Now button 805. If one does not wish to join, one may instead click the Cancel button 806.

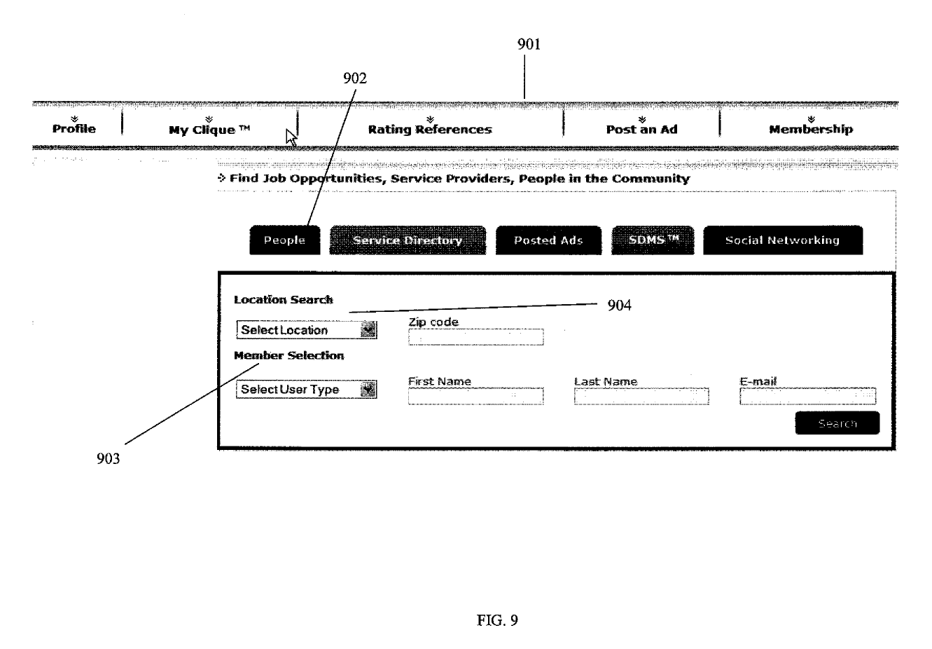

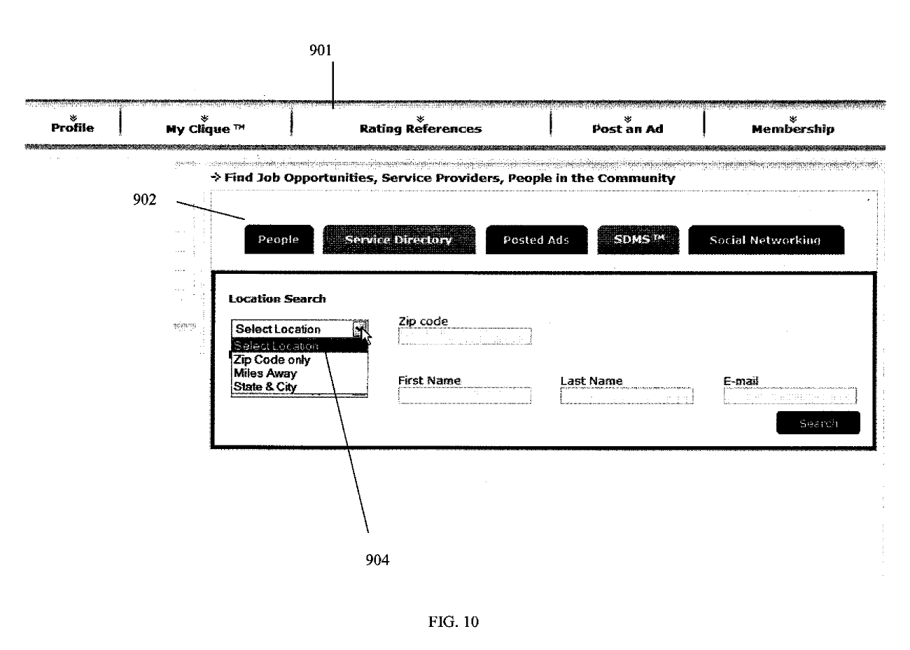

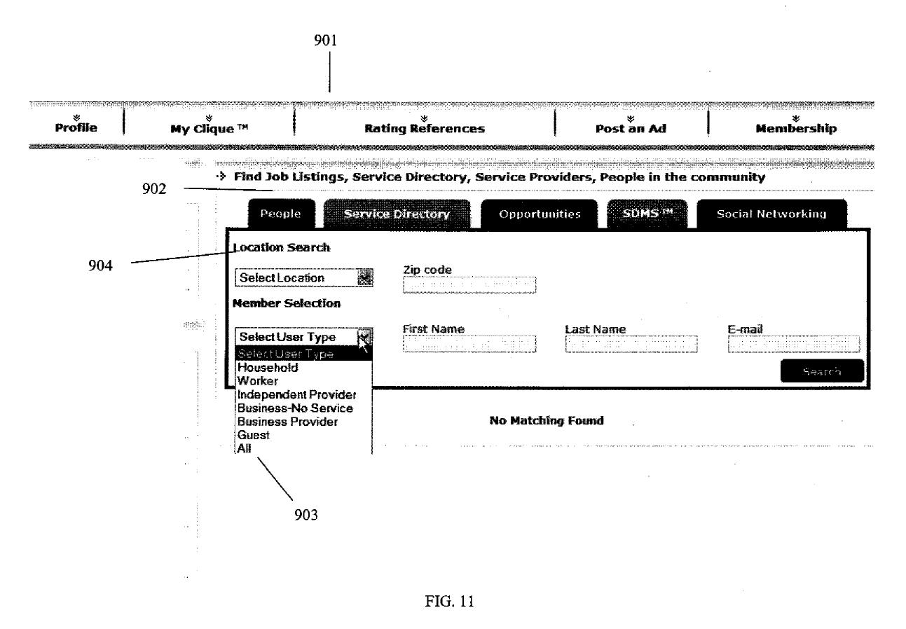

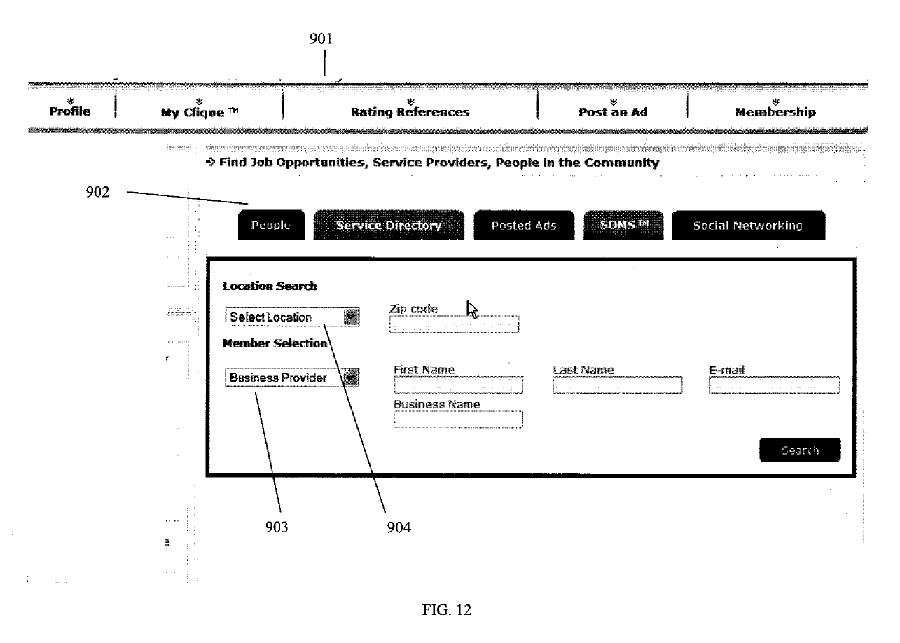

FIGS. 9-12 are embodiments of the People Search page 901. To reach this page, one clicks the People tab 902 which appears on the Main Page or any of the search pages. In some embodiments, one may then search for a person by selecting the type of user from Member Selection pull-down menu 903. The choices are: Household, Worker, Independent Provider, Business—No Service, Business Provider, Guest, or All. In some embodiments, one may input a First Name or a Last Name. For a business, one may input the Business name. In some embodiments, one may further limit the search by selecting a location modifier 904. The pull-down menu contains the choices: Zip Code, Miles Away, and State & City. For example, if Zip Code is chosen, one enters the zip code to which one whishes to confine the search.

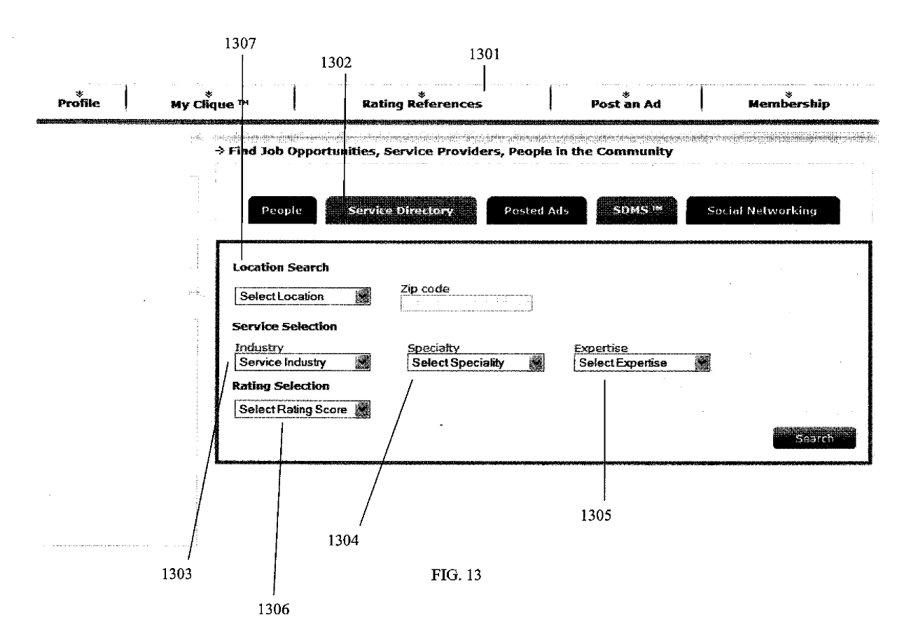

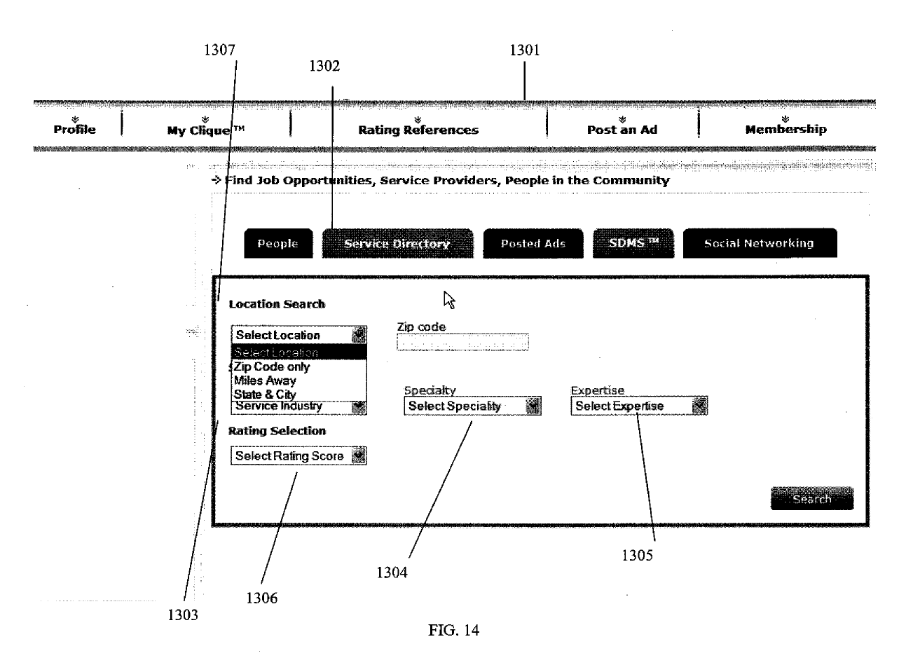

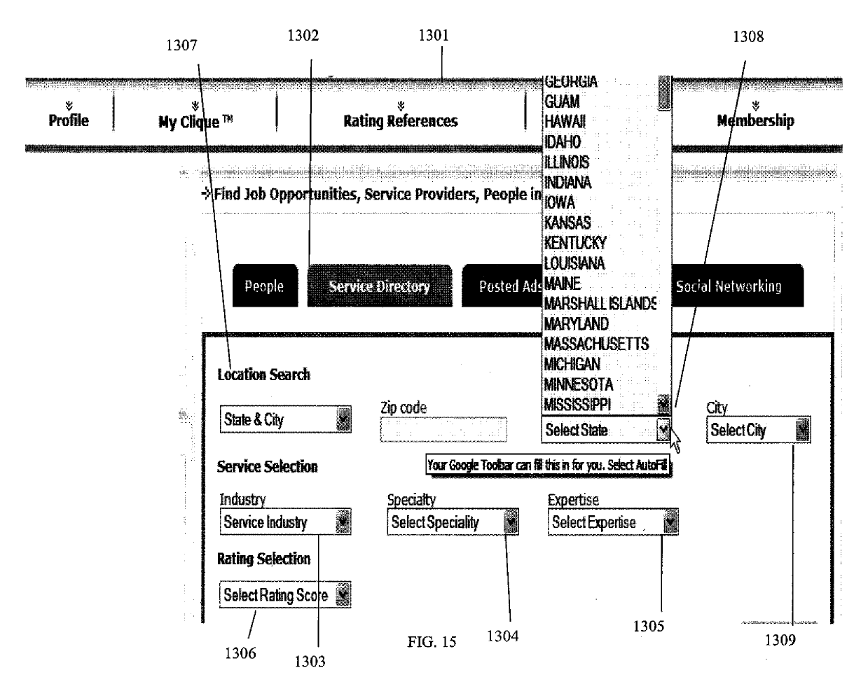

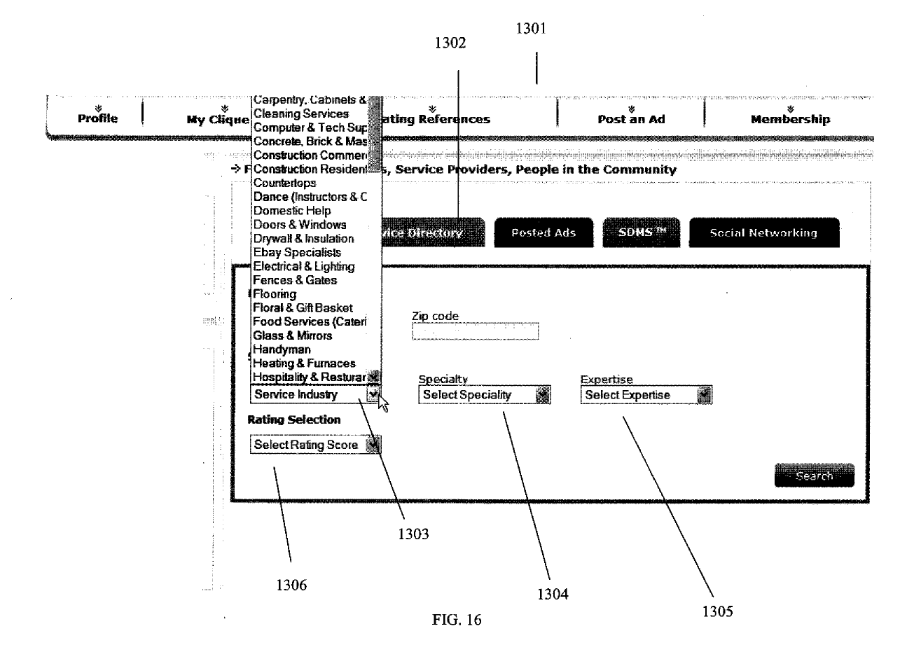

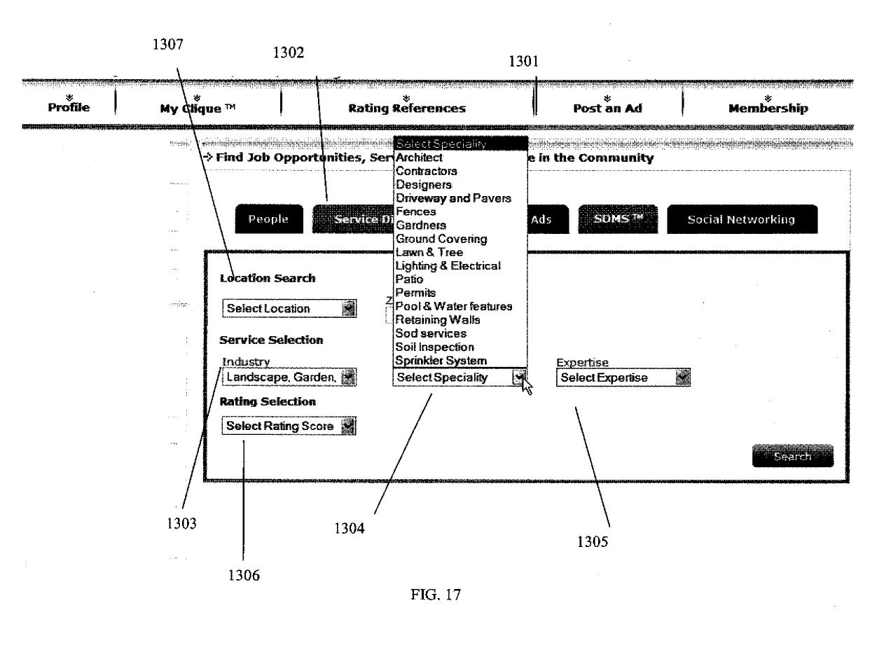

FIGS. 13-17 are embodiments of a Service Directory page 1301. To reach this page, one clicks the Service Directory tab 1302 which appears on the Main Page or any of the search pages. In some embodiments, one selects the industry one wishes to search from the Industry drop-down menu 1303. One the selects the specialty (in some embodiments, the Industry Sector from the Specialty drop-down menu 1304. Finally, in some embodiments, one selects the expertise (in some embodiments, the task or the skill) from the Expertise drop-down menu 1305. In some embodiments, one may limit the search by location 1307. In some embodiments, as in FIG. 15, when one selects State & City two new drop-down menus appear—one listing state 1308 and one listing the cities of a selected state 1309. To limit the search by rating, one selects a rating from the Rating Selection drop-down menu 1306.

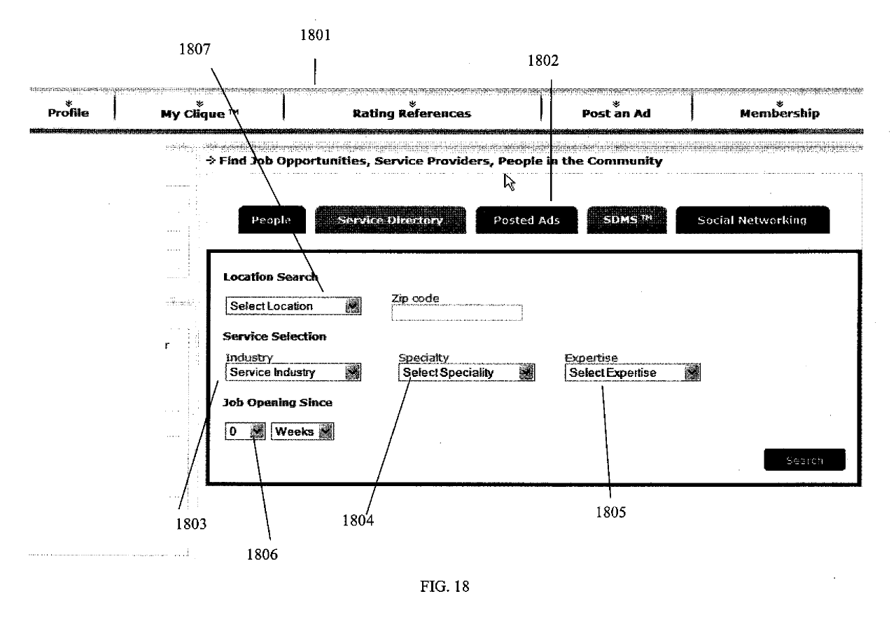

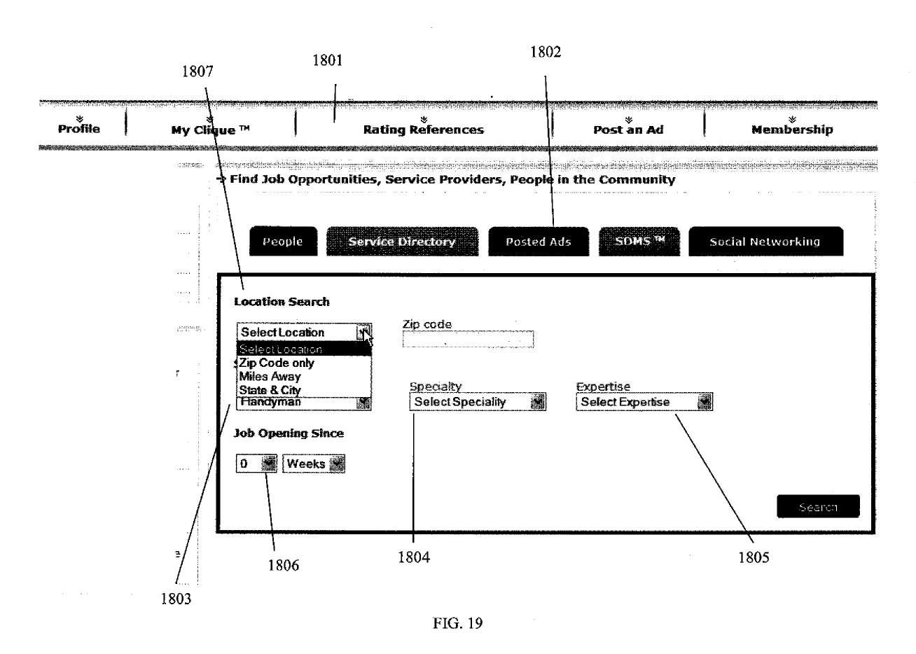

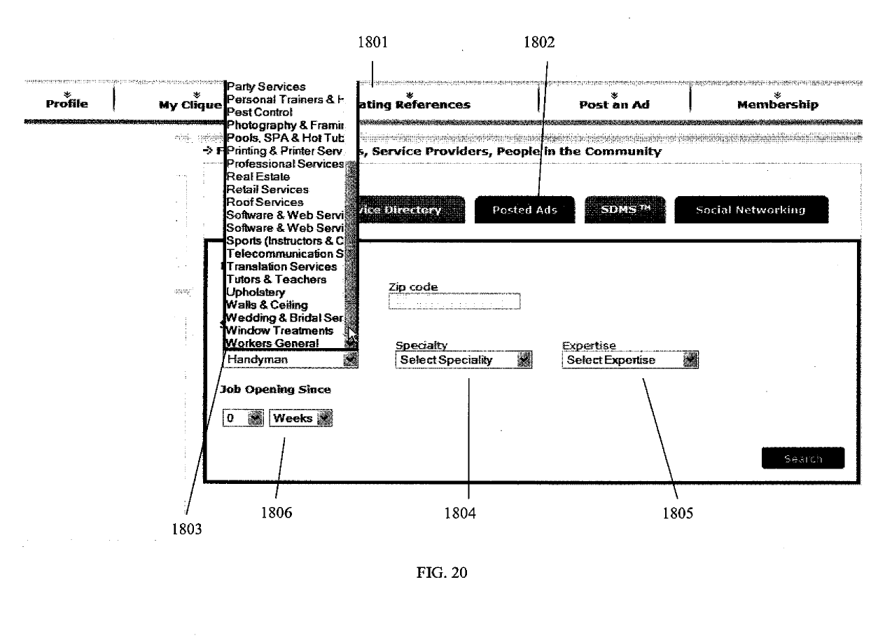

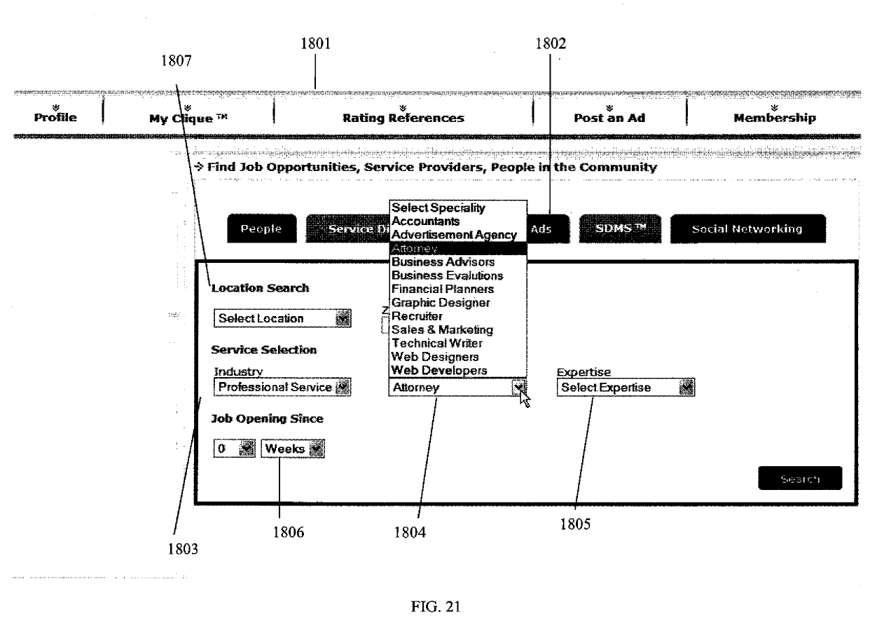

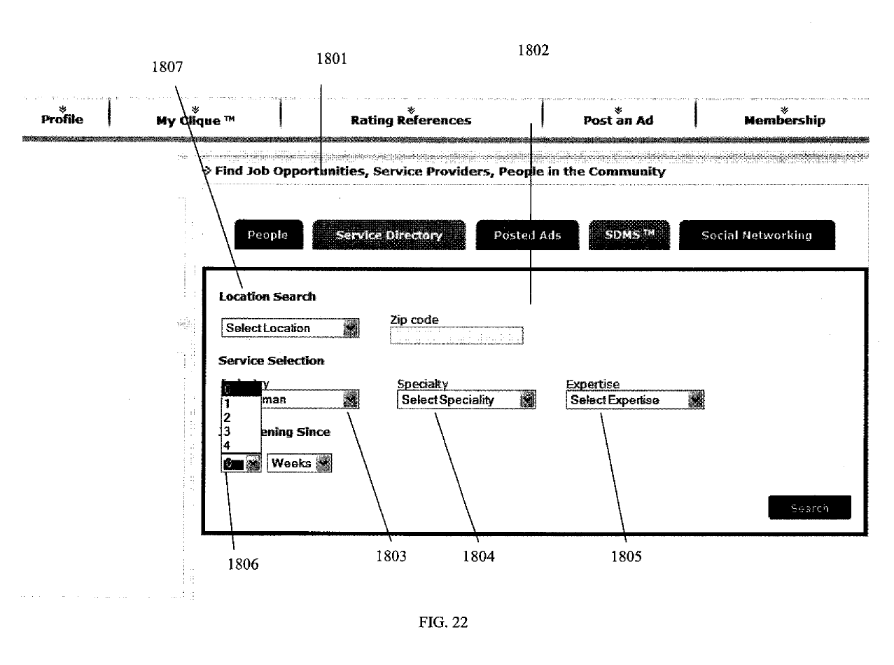

FIGS. 18-22 are embodiments of a Posted Ads page 1801. To reach this page, one clicks the Posted Ads tab 1802 which appears on the Main Page or any of the search pages. In some embodiments, one selects the industry one wishes to search from the Industry drop-down menu 1803. One then selects the specialty (in some embodiments, an Industry Sector from the Specialty drop-down menu 1804. Finally, in some embodiments, one selects expertise (in some embodiments, the task or the skill) from the Expertise drop-down menu 1805. In some embodiments, one may limit the search by how long the advertisement has been posted. To limit the search by how long the job has been posted, one selects a time period from the Job Opening Since drop-down menus 1806. In some embodiments, one may limit the search by location 1309.

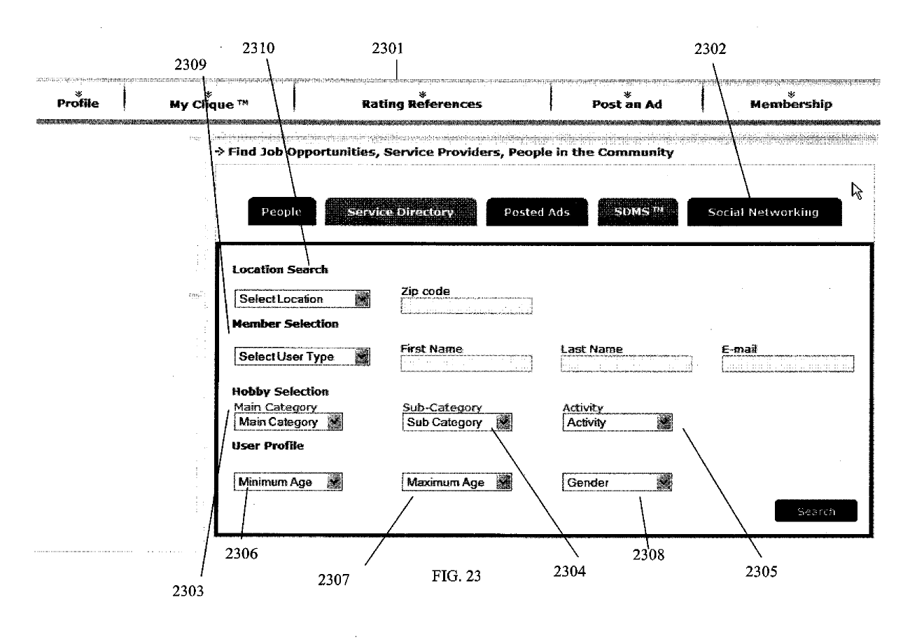

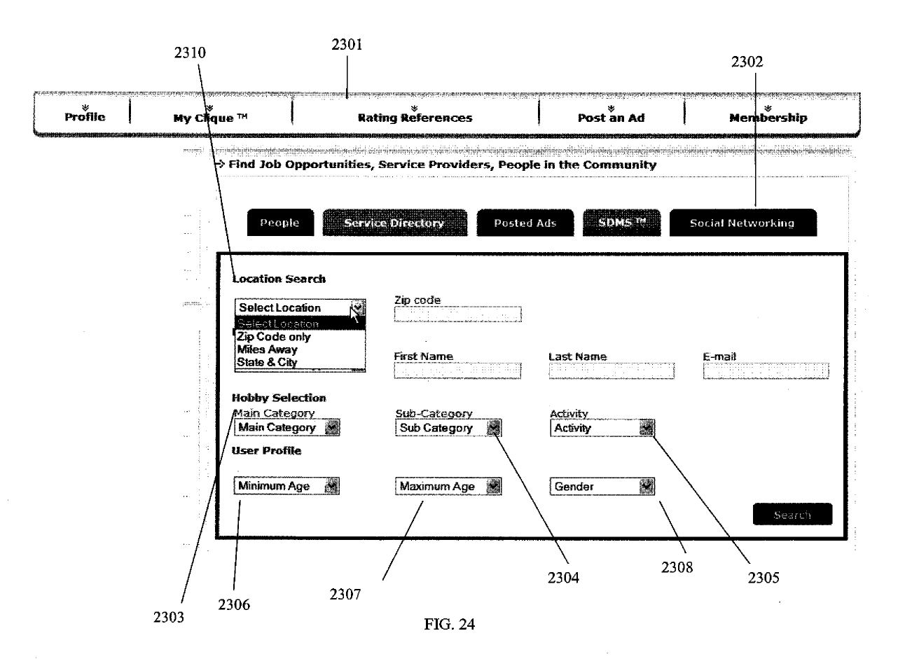

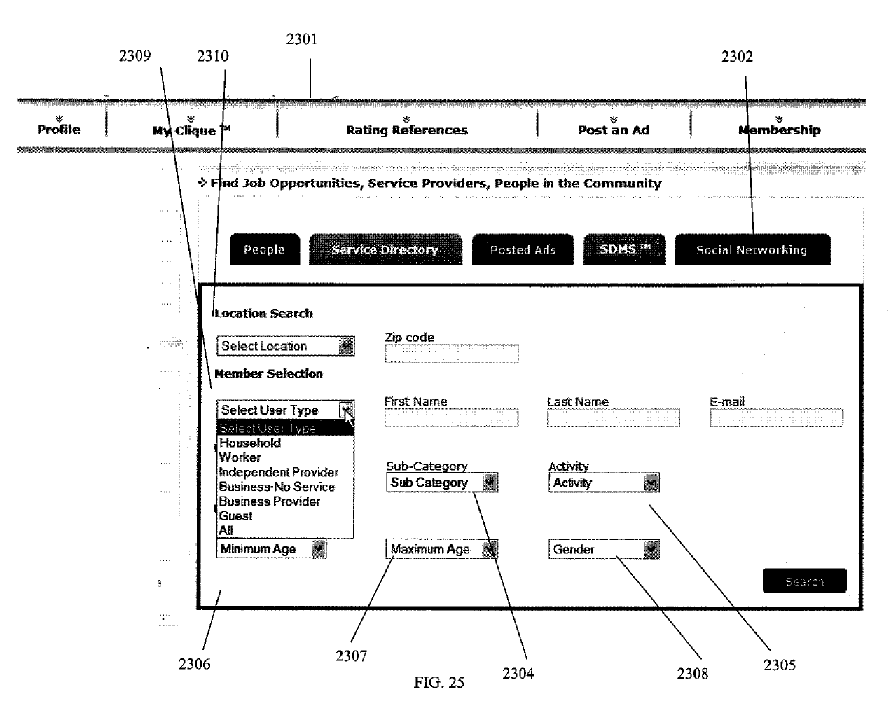

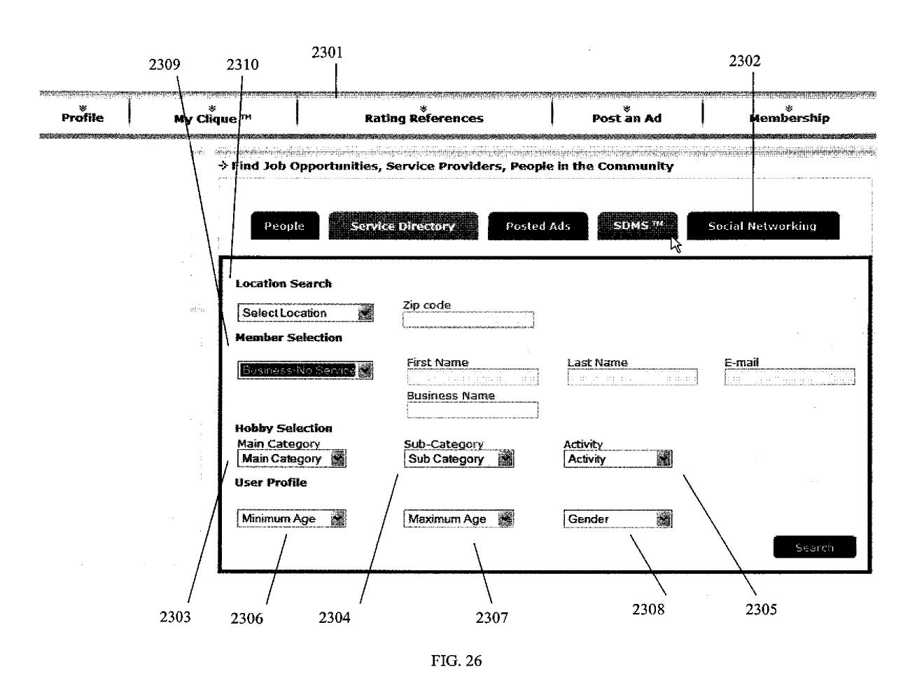

FIGS. 23-26 are embodiments of the Social Networking page 2301. To reach this page, one clicks the Social Networking tab 2302 which appears on the Main Page or any of the search pages. In some embodiments, one searches for a person by selecting the type of user from Member Selection pull-down menu 2309. The choices are: Household, Worker, Independent Provider, Business—No Service, Business Provider, Guest, or All. In some embodiments, one may input a First Name or a Last Name. For a business, one may input the Business name. In some embodiments, one may select a user based on hobbies. First, one selects the main category of the hobby from the Main Category drop-down menu 2303. Next, one selects the hobby sub-category from the Sub-Category drop-down menu 2304. Finally, in some embodiments, one selects the activity from the Activity drop-down menu 2305. In some embodiments, one may further limit the search by the user's age by selecting from the Minimum Age 2306 and Maximum Age 2307 drop-down menus. In some embodiments, one may further limit the search by the user's gender by selecting a gender from the Gender drop-down menu 2308. In some embodiments, one may limit the search by location 2310.

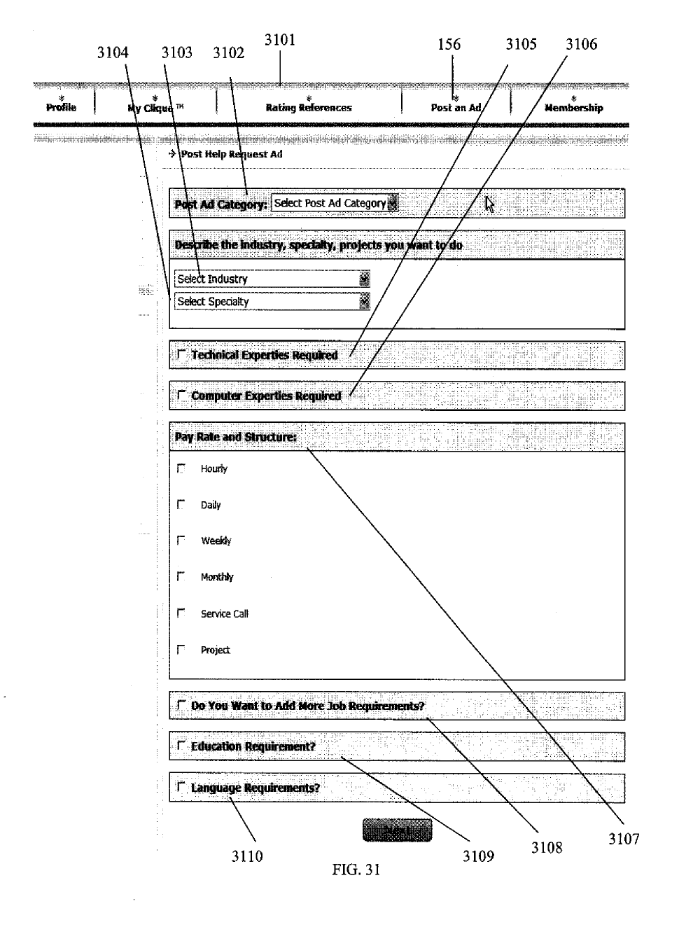

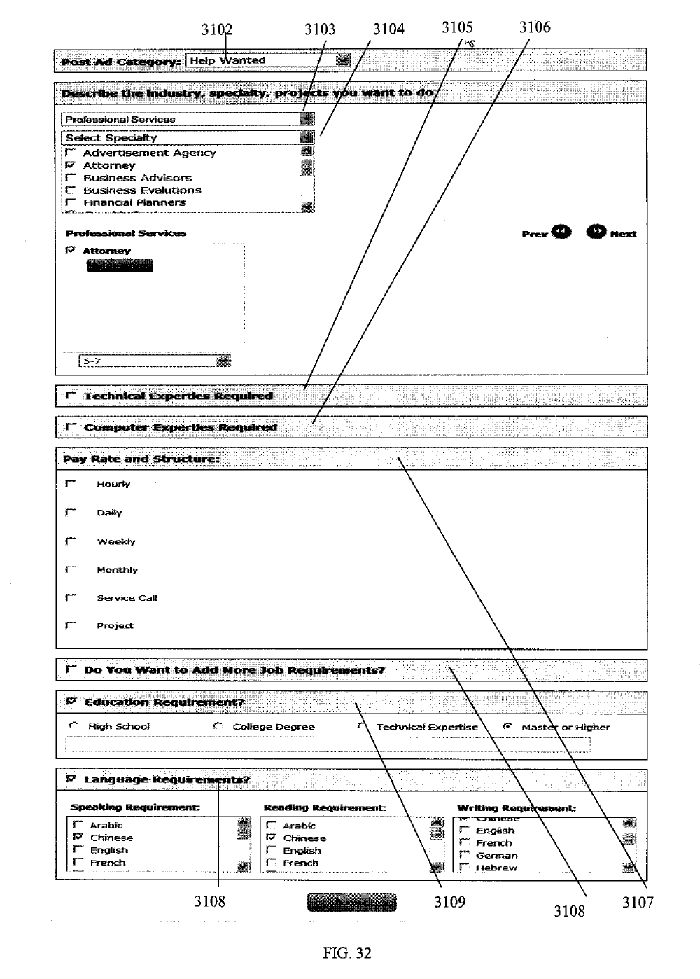

FIGS. 31 and 32 are embodiments of the page which allows one to Post an Ad 3101. To reach this page, one clicks the Post an Ad link 156 which appears on the Main Page or any of the search pages. In some embodiments, the poster selects an ad category from the Ad Category drop-down menu 3102. In some embodiments, the poster selects an industry from the Industry drop-down menu 3103. In some embodiments, one selects a specialty (in some embodiments, it is called industry sector) from the Specialty drop-down menu 3104. In some embodiments, the poster may require technical expertise by check the Technical Expertise box 3105. In some embodiments, the poster may require computer expertise by checking the Computer Expertise box 3106. In some embodiments, the poster may indicate a pay structure by checking the appropriate box 3107. In some embodiments, the poster may add additional job requirements 3108. In some embodiments, the poster may indicate education requirements by checking the Education Requirement box 3109. In some embodiments, the poster may also indicate language requirements by checking the Language Requirements box 3110.

While the invention has been described in detail with reference to a limited number of industry sectors, the person skilled in the art will recognize that the methodology described herein can be applied to any industry sector. Any industry sector can be analyzed to determine the precise skills that are possessed by service providers, and utilized by consumers, within the industry sector. Likewise, those skills can be organized by category (industry) and sub-category into a process-oriented hierarchy, such that the hierarchical structure can be utilized by providers and consumers of services to match needs of consumers to the skills possessed by service providers. In some embodiments, the invention provides a system adapted to implement the described method, wherein the system comprises at least one server and software adapted to implement the method. The at least one server comprises storage for the databases, inputs and outputs for receiving and transmitting data, a processing unit and memory for running the software adapted to implement the method described herein.

The person skilled in the art will recognize that the methods and systems provided herein are adaptable to any number of milieus of human endeavor and are scalable to a variety of platform sizes. The methods and systems may be implemented on a large scale, e.g. on the Internet, or on a smaller scale, e.g. in a business. The methods and systems provided herein permit efficient storage, searching and presentation of information in a variety of milieus, including industrial settings, social networking, etc. Indeed, information for a variety of milieus of human endeavor can be integrated in a single platform, thereby allowing the sharing of information relating to products and services, social networking, resume sharing, etc. on a single platform, such as can be provided on the Internet or an intranet. The person skilled in the art, after having considered the disclosure provided herein, will be able to adapt these methodologies to a host of different fields of human endeavor.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method, comprising:
(a) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database;
(b) receiving a selection of at least one entity attribute for the first entity, wherein said at least one entity attribute is selected from the attribute database;
(c) recording the at least one selected entity attribute in an attribute field in a first entity record in an entity database;
(d) providing to a second entity a search engine adapted to permit the second entity to select at least one attribute for which to search from the attribute database;
(e) receiving at least one search attribute selected by the second entity from the attribute database;
(f) searching the contact database for an entity record containing an attribute that matches the search attribute; and
(g) providing information for at least the first entity to the second entity.

2. The method of claim 1, further comprising receiving registration information including identifying information and/or contact information for the first entity, and storing said registration information in a registration information field of the entity record in the entity database.

3. The method of claim 2, wherein receiving registration information occurs after step (a) and before step (d).

4. The method of claim 1, wherein receiving the at least one search attribute of (e) is performed by a hierarchal click-through search engine.

5. The method of claim 1, wherein receiving the at least one entity attribute is performed by a hierarchal click-through attribute selection engine.

6. A computer-implemented method, comprising:
(a) providing an attribute database, wherein attributes are arranged in a multi-level hierarchy comprising at least three levels, wherein a first level comprises at least one category that is related to multiple subcategories in a second level and at least one sub-category in said second level is related to multiple attributes stored in the attribute database;
(b) receiving registration information including identifying information and contact information for a first entity, and storing said registration information in a registration information field of a record in an entity database;
(c) receiving a selection of at least one attribute for the first entity, wherein said at least one attribute is selected from the attribute database;
(d) recording the at least one selected attribute in an attribute field in the entity record corresponding to the first entity.

7. The method of claim 1, wherein receiving the at least one attribute of (c) is performed by a hierarchal click-through search engine.

8. The method of claim 6, further comprising: (e) providing to a second entity a search engine adapted to permit the second entity to select at least one attribute from the attribute database; (f) receiving at least one search attribute selected by the second entity from the attribute database; (g) searching the entity database for an entity record containing an attribute that matches the search attribute; and (h) returning entity information for at least the first entity to the second entity.

9. A computer-implemented method, comprising:
(a) providing an entity database comprising a plurality of entity records, each entity record comprising at least one registration information field populated with registration information for an entity and at least one attribute field corresponding to the entity;
(b) providing an attribute database, wherein attributes are arranged in a multi-level hierarchy comprising at least three levels, wherein a first level comprises at least one category that is related to multiple sub-categories in a second level and at least one sub-category in said second level is related to multiple attributes stored in the attribute database;
(c) providing to a searcher a search engine adapted to permit the searcher to select at least one attribute for which to search from the attribute database;
(d) receiving at least one search attribute selected by the searcher from the attribute database;
(e) searching the entity database for an entity record containing an entity attribute that matches the search attribute; and
(f) providing information for at least the first entity to the searcher.

10. The method of claim 9, wherein receiving the at least one search attribute of (c) is performed by a hierarchal click-through search engine.

11. A computer system comprising:
(a) a multi-level hierarchal database comprising a multi-tier structure having at least three levels, at least one category of the first level being related to a plurality of sub-categories of a second level, and at least one sub-category of the second level being related to a plurality of attributes of a third level;
(b) an entity database containing entity records containing registration information fields and attribute fields for a plurality of entities, wherein the attribute fields contain entity attributes selected from the attribute database of (a);
(c) a means for receiving registration information and attributes corresponding to a plurality of entities, wherein the attributes must be selected from the multi-level hierarchal database of (a);
(d) a means for receiving search information, wherein the search information includes at least one search attribute, and at least one search attribute must be selected from the multi-level hierarchal database of (a);
(e) a means for comparing the search information from (d) with the entity attributes corresponding to each of the plurality of entities recorded in the entity database; and
(f) a means for displaying the results of the search from (e).

12. The system of claim 1, wherein the means for receiving search information includes a hierarchal click-through search engine.
